(19) United States
(12) Patent Application Publication
(10) Pub. No.: US 2004/0229044 A1
(43) Pub. Date: Nov. 18, 2004

(54) Electrophotographic image forming process and electrophotographic image receiving material

(76) Inventor: Yasutomo Goto, Shizuoka (JP)

Correspondence Address: YOUNG & THOMPSON, 745 SOUTH 23RD STREET 2ND FLOOR, ARLINGTON, VA, 22202

(21) Appl. No.: 10/732,379

(22) Filed: Dec. 11, 2003

(30) Foreign Application Priority Data
Dec. 11, 2002 (JP) 2002-359673

(51) Int. Cl. G03G 15/20; B32B 9/04

(52) U.S. Cl. 428/421; 430/124; 428/446

(57) ABSTRACT

An electrophotographic image receiving sheet for use in an electrophotography has a toner image receiving layer having breaking extension greater than 0.2%. The toner image receiving layer contains preferably a water-soluble polymer or a water-dispersant polymer as a major component.

### BACKGROUND OF THE INVENTION

1. Field of the Invention

The present invention relates to an electrographic image receiving material of high quality that is excel at glossiness and prevented from being cracked and/or loosing its surface gloss due to flexure or curling and an electrophotographic image forming process for use with the electrophotographic image receiving material.

2. Description of Related Art

Electrophotographic processes have been widely used in an output equipments of a copy machine or a personal computer because of dry processing, high speed printing and printability to general-purpose papers (plain papers and quality papers). However, when printing out an image such as a human face photograph or a landscape photograph, it is hard to form a required image quality on, in particular, a general-purpose paper because of poor glossiness. In order to provide a photograph printed by an Electrophotographic process, it is necessary for such a paper used as an electrophotographic image receiving sheet to have a finely smooth surface. In addition, it is essential for an image receiving sheet as used in the electrophotographic process to allow toner to dig into an image receiving layer of the paper during a fixing process after the toner has been transferred so as thereby to make the paper surface finely smooth.

For this reason, there have been proposed various techniques to improve smoothness and glossiness of the surface of an electrophotographyic image receiving sheet smooth. One of electrophotographyic image receiving sheets that is disclosed, for example, in Japanese Unexamined Patent Publication No 200-275891 comprises more than one constitutive layers formed on a substrate sheet which include a toner image receiving layer and at least one of which contains a plasticizing material. The electrophotographic image receiving sheet is characterized in that the a toner image receiving layer has a melt-off starting temperature higher than 30° C. but lower than a temperature 10° C. higher than a melt-off starting temperature of the resin toner.

Although this technique has been proposed with the goal of forming a high quality reflected toner image i.e. a non-textured image and/or an image without whit spots, and leaves much to be improved for the reason that the relationship between physical properties and performance of the image receiving layer has been unconsidered.

### SUMMARY OF THE INVENTION

It is therefore an object of the present invention to provide an electrographic image receiving material of high quality that is excel in surface glossiness and prevented from being cracked and/or loosing surface gloss due to flexure or curling and an electrophotographic image forming process suitable for the electrophotographic image receiving material.

The above object of the present invention is accomplished by an electrophotographic image receiving material comprising a substrate material and a toner image receiving layer formed on the substrate material that has breaking extension greater than 0.2%.

The toner image receiving layer has a thickness in a range of desirably from 1 to 30 μm. Further, the toner image receiving layer contains either one of a water-soluble polymer and a water-dispersant polymer. It is preferred for the substrate material to comprise one selected from a group of base paper, synthetic paper, synthetic resin paper, coated paper and laminated paper.

The above object of the present invention is further accomplished by an electrophotographic image forming process for use with the electrophotographic image receiving sheet as set forth above that comprises the steps of forming a toner image on the electrophotographic image receiving sheet, heating and pressurizing the electrophotographic image receiving sheet with a toner image fixing belt and a toner image fixing roller, cooling the electrophotographic image receiving sheet while conveying the electrophotographic image receiving sheet with a surface on which an toner image is formed in contact with the toner image fixing belt, and removing the electrophotographic image receiving sheet from the toner image fixing belt.

The electrophotographic image forming process may further comprise the step of fixing the toner image with a heating roller before heating and pressurizing the electrophotographic image receiving sheet. In this process, it is preferred for the toner image fixing belt to have a surface layer of fluorocarbone siloxane rubber formed uniform in thickness thereon. Further, it is preferred for the toner image fixing belt to have an under surface layer of silicon rubber formed uniform in thickness over which the surface layer of fluorocarbons siloxane rubber is formed. It is further preferred to use fluorocarbons siloxane rubber having at least one of a perfluoroalkyl ether group and a perfluoroalkyl group in a backbone principal chain.

According to the electrophotographic image forming material, the toner imaging layer takes on appropriate solid state properties and performance with the consequence that the electrographic image receiving material is excel in surface glossiness and prevented from being cracked and/or loosing surface gloss due to flexure or curling, resulting from that the toner image receiving layer formed on the substrate material has breaking extension greater than 0.2%.

According to the electrophotographic image forming process, even when using an electrophotographic apparatus which does not use fixing oil, it is realized that the electrophotographic image forming material is stably conveyed without causing offset to the toner image fixing roller and/or the toner image fixing belt with the consequent that an image formed on the electrophotographic image forming material is satisfactory glossy and sounds like a quality photograph.

### BRIEF DESCRIPTION OF THE DRAWINGS

The foregoing and other objects and features of the present invention will be clearly understood from the following detailed description when read with reference to the accompanying drawing, in which the single figure is a schematic view of a belt fixing type of electrophotographic apparatus according to a preferred embodiment of the present invention.

### DETAILED DESCRIPTION OF THE PREFERRED EMBODIMENTS

An electrophotographic image receiving material of the invention comprises a substrate paper sheet, a toner image receiving layer formed on the substrate paper sheet and additional layers such as an intermediate layer, a protective layer, an undercoating layer, cushioning layer, a charge adjusting (antistatic) layer, a reflective layer, a color adjusting layer, a storage stability improvement layer, an anti-adhesion layer, an anti-curling layer, a smoothing layer or the like that are selected according to need. Each of these layers may have a single layer structure or a multi-layered structure.

There are various papers available as the substrate paper sheet, e.g. base paper, synthetic paper, synthetic resin paper or film, coated paper, laminated paper, etc. The substrate paper sheet may have a single layer structure or a muntilayer lamination structure.

There is no limit to materials for the base paper, and any one of materials that are widely used for making base papers may be selected. These materials include, for example, natural pulp such as softwood or coniferous tree pulp or hardwood or broad leaf tree pulp, synthetic pulp made of a plastic material such as polyethylene or polypropylene, and a mixture of natural pulp and synthetic pulp. Although it is preferred to use bleached broad leaf tree kraft pulp (LBKP) for the base paper in light of improving surface smoothness, rigidity and dimensional stability (curling property) all together to a sufficient and balanced level, it is allowed to use bleached coniferous tree kraft pulp (NBKP) or broad leaf sulphite pulp (LBSP). Further, it is appropriate to use broad leaf sulphite pulp that is long in fiber length by nature. In addition to the base paper made of the material enumerated above, various combination paper may be used.

The pulp is beaten to pulp slurry (which is referred to as pulp stuff in some cases) with a beater or a refiner. It is allowed to add various additives, e.g. a loading material, a dry strength stiffening agent, a sizing agent, a wet strength stiffening agent, a fixing agent, a pH adjuster and other chemical conditioners and other agents, to the pulp slurry according to need.

Materials available for the loading material include, for example, calcium carbonate, clay, kaolin, a white earth, talc, a titanium oxide, a diatom earth, barium sulfate, an aluminum hydroxide, a magnesium hydroxide, etc.

Materials available for the dry strength stiffening agent include, for example, cationic starch, cationix polyacrylamide, anionic polyacrylamide, amphoteric polyacrylamide, carboxy-modified polyvinyl alcohol, etc.

Materials available for the sizing agent include, for example, a fatty acid salt, rosin, a rosin derivative such as maleic rosin, paraffin wax, a compound containing a high fatty acid such as a alkylketene dimmer, an alkenyl anhydrate succinic acid (ASA), an epoxidized fatty acid salt or the like.

Materials available for the wet strength stiffening agent include, for example, polyamine polyamide epichlorohydrin, a melamine resin, a urea resin, an epoxidized polyamide resin, etc.

Materials available for the fixing agent include, for example, a polyvalent metal salt such as aluminum sulfate or aluminum chloride, a cationic polymer such as cationic starch or the like.

Materials available for the pH adjuster include, for example, caustic soda, sodium carbonate, etc.

Materials that may be added as an additive to the pulp slurry include, for example, a deforming agent, dye, a slime controlling agent, a fluorescent brightening agent, etc. In addition, it is allowed according to need to use a softening agent such as shown in “New Handbook For Paper Processing” 1980 Edition (Paper Chemicals Times), pages 554 and 555.

A processing liquid that is used for a surface sizing process may contain a water-soluble polymer, a sizing agent, a water-resisting agent, pigment, a pH adjuster, dye, a fluorescent brightening agent, etc.

Materials available for the water-soluble polymer include, for example, cationic starch, polyvinyl alcohol, carboxy-modified polyvinyl alcohol, acrboxymethyl cellulose, hydroxyethyl cellulose, cellulose sulfate, gelatin, casein, sodium polyacrylate, a sodium salt of styrene-maleic anhydrate copolymer, polystyrene sulphonate sodium, etc.

Materials available for the water-resisting agent include, for example, a latex emulsion such as a styrene-butadiene copolymer, an ethylene-vinyl acetate copolymer, polyethylene, vinylidene chloride copolymer or the like, polyamide polyamine epichlorohydrin, etc.

Materials available for the pigment include, for example, calcium carbonate, clay, kaolin, talc, barium sulfate, a titanium oxide, etc.

It is desirable for the base paper to have a ratio of longitudinal Young's modulus (Ea) to transverse Young's modules in a range of from 1.5 to 2.0 in light of improving the rigidity and dimensional stability (curling property) of electrphographic image receiving sheet. If the ratio (Ea/Eb) exceeds the lower limit of 1.5 or the upper limit of 2.0, the base paper is apt to cause deterioration of rigidity and curling property of the electrphographic image receiving sheet. This is undesirable for the electrphographic image receiving sheet in terms of traveling ability.

The base paper used for the electrophotographic image receiving sheet has a smoothness of greater than 210 seconds, and more desirably greater than 250 seconds, at the side of image receiving surface when measured by Oken scale (which is a scale on the code of JAPAN TAPPI Rule No. 5 B and hereafter referred to as an Oken smoothness). If the Oken smoothness is lower than 210 seconds, a toner image formed on the image receiving surface suffers deterioration of image quality. Although there is no upper limit of smoothness put on the base paper, it is practically appropriate to set an upper limit of smoothness to approximately 600 seconds, and more desirably 500 seconds.

Generally, it has been proved that what is called “firmness” of paper varies depending upon beating manners. Elastic force (an elastic coefficient) of paper manufactured from beaten pulp can be utilized as a key factor for defining the degree of “firmness” of the paper. In particular, since the dynamic elastic coefficient of paper that shows a solid state property of a visco-elastic body is closely related to paper density, the elastic coefficient of paper is expressed in terms of an acoustic propagation velocity through paper that is measured by an ultrasonic transducer as below.

E=ρc²(1−n²)

where E is the dynamic elastic coefficient;

ρ is the paper density;

c is the acoustic propagation velocity through paper

n is Poisson's ratio.

Because Poisson's ratio of ordinary paper is 0 (zero), the dynamic elastic coefficient can be approximated in terms of the following equation.

E=ρc²

That is, the elastic coefficient is easily obtained by substituting paper density and an acoustic propagation velocity of paper for ρ and c in the above equation, respectively. An acoustic propagation velocity of paper can be measured by an instrument well known in the art such as, for example, Sonic Tester SST-110 (which is manufactured by Nomura Co., Ltd.).

It is appropriate for the base paper to have a thickness normally in a range of from 30 μm to 500 μm, more desirably in a range of from 50 μm to 300 μm, and the most desirably in a range of from 100 μm to 250 μm. It is also appropriate for the base paper to have a basic weight desirably in a range of from 50 g/m² to 250 g/m² and more desirably in a range of from 100 g/m² to 200 g/m². Specifically, it is preferred to use a bond paper and paper listed in “Fundamentals of Photographic Engineering-Silver Salt Photography-” pages from 223 to 240, edited by Japanese Society of Photograph (published 1979 by Corona Co., Ltd.

In order to create desired average surface roughness on a paper surface, it is preferred to use pulp fibers having fiber length distributed as disclosed in, for example, Japanese Unexamined Patent Publication No.58-68037. Specifically, according to the distribution of fiber length, the pulp fibers contain a total part of residual pulp fibers screened with a 24-mesh screen and residual pulp fibers screened with a 42 mesh screen of 20 to 45 weight % and a part of residual pulp fibers screened with 24 mesh screen of less than 5 weight %. The base paper can be adjusted in average surface roughness by applying heat and pressure for surface treatment using a machine calender or a super calender.

The synthetic paper comprises polymer fiber except cellulose as a major component. Preferred examples of the polymer fiber include a polyolefin fiber such as a polyethylene fiber or a polypropylene fiber.

Materials available for the synthetic resin paper or film include a polypropylene film, an oriented polyethylene film, an oriented polypropylene film, a polyester film, an oriented polyester film, a nylon film a film tinged white due to orientation, a white film containing a white pigment, etc.

The coated paper is prepared by coating either or both surfaces of a base paper sheet with a material such as resin, rubber latex or a high polymer. The amount of coating is different according to intended applications of the coated paper. There are various coated paper available for the substrate paper sheet include, for example, art paper, cast-coated paper, Yankee paper, etc. It is preferred to use thermoplastic resins as the coating material such as listed below.

(I) A polyolefin resin such as a polyethylene resin or a polypropylene resin, a polyolefin resin of olefin such as ethylene or propylene, and a vinyl monomer other than them

(II) A thermoplastic resin having an ester bond such as, for example, a polyester resin obtained resulting from condensation of a dicarboxylic acid component (which may be substituted with a sulfonic acid group or a carboxyl group) and an alcohol component (which may be substituted with a hydroxyl group); a polyacrylic ester resin; or a polymethacrylic ester resin such as polymethyle methacrylate, polybutyl methacrylate, polymethyle acrylate or polybutyl acrylate, a polycarbonate resin, a polyvinyl acetate resin, a styrene acrylic resin, a styrene-methacrylic eater copolymer resin, vinyl toluene acrylic resin or the like.

More specific examples of the thermoplastic resin are disclosed in, for example, Japanese Unexamined Patent Publications Nos. 59-101395, 60-294862, 63-7971, 63-7972 and 63-7973.

Further, commercially available thermoplastic resins include, but not limited to, Vyron 103, Vyron 200, Vyron 280, Vyron 290, Vyron 300, Vyron GK-130 and Vyron GK-140 (which are manufactured by Toyobo Co., Ltd.); Tafuton NE-382, Tafuton U-5, Tafuton ATR-2009 and Tafuton ATR-2010 (which are manufactured by Kao Co., Ltd.); Elitel UE3500, Elitel UE3210, Elitel XA-8153, Elitel KZA-7049 and Elitel KZA-1449 (which are manufactured by Unitika Ltd.); Polyester TP-220 and Polyester R-188 (which are manufactured by Nippon Synthetic Chemical Industry Co., Ltd.); thermoplastic resins of Hyros series (which are manufactured by Seiko Chemical Industry Co., Ltd.).

(III) Polyurethane resin;

(IV) Polyamide resin, urea resin, etc.;

(V) Polysulfone resin;

(VI) Polyvinyl chloride resin, polyvinyliden chloride resin, vinyl chloride-vinyl acetate copolymer resin, vinyl chloride-vinyl propionate copolymer resin;

(VII) Polyol resin such as polyvinyl butyral, cellulose resin such as ethyl cellulose resin or cellulose acetate resin;

(VIII) Polycaprolactone resin, styrene-maleic anhydride resin, polyacrilonitrile resin, polyether resin, epoxy resin, phenolic resin.

These thermoplastic resins may be used individually or in any combination of two or more.

It is allowed for each of the thermoplastic resins to contain a brightening agent, a conducting material, a loading material and pigment or dye such a titanium oxide, an ultramarine blue pigment or carbon black according to need.

A laminated paper sheet is prepared by laminating a sheet of base paper with a resin sheet or film, a rubber sheet or film, or a polymer sheet or film. Available laminating materials include polyolefin, polyvinyl chloride, polyethylene terephthalate, polystyrene, polymethacrylate, polycarbonate, polyimide, triacetylcellulose, etc. which may be used individually or in any combination of two or more.

Generally, the polyolefin is often prepared by utilizing low density polyethylene (LDPE). However, in order for the substrate sheet to have an improved heat tolerance, it is desirable to use polypropylene, a blend of polypropylene and polyethylene, high density polyethylene (HDPE), a blend of high density polyethylene and low density polyethylene, etc. In particular, the blend of high density polyethylene and low density polyethylene is more desirable in light of cost and laminating adaptability. The blending ratio (weight ratio) of high density polyethylene to low density polyethylene is desirably between 1:9 and 9:1, more desirably between 2:8 and 8:2, and most desirably between 3:7 and 7:3. In the case where the opposite surfaces of the substrate sheet are coated with a thermoplastic resin, it is preferred to form a coating layer of high density polyethylene or a blend of high density polyethylene and low density polyethylene. In this instance, the polyethylene is not bound by molecular weight and is, however, desirable to have a melt index between 1.0 to 40 g per 10 minutes, even though it is of higher density or of low density, as long as it is suitable for extrusion adaptability. In this instance, these sheets or films may be treated so as to have white reflexivity. This treatment is achieved by blending pigment such as titanium oxide or the like in the sheet or the film.

It is preferred for the substrate sheet to have a thickness between 25 μm and 300 μm, more preferably between 50 μm and 260 μm, and most preferably between 75 μm and 220 μm. The substrate sheet may have appropriate stiffness according to types of usage and, in the case of being incorporated in an electrophotographic image receiving sheet having photographic image quality, is preferred to be similar to those for sliver color films.

The toner image receiving layer, that is a receptor to color toner or black toner for forming an image, has functions of receiving toner from an intermediate transfer sheet or a developing drum by the aid of static electricity and pressure in a transfer printing process and fixing the toner with heat and pressure in a fixing process.

It is necessary for the toner image receiving layer to have breaking extension greater than 0.2%, desirably greater than 0.27% and more desirably greater than 0.5%. In this instance, the breaking extension is represented as a percentage of elongation of a sample at an occurrence of fracture relative to the original length of the sample. Although there is no upper limitation on the breaking extension, the toner image receiving layer may cause cracks and/or loose its surface gloss due to flexure or curling with the consequence that the electrophotographic image receiving sheet suffers deterioration of surface glossiness if the breaking extension is less than 0.2%.

The breaking extension of toner image receiving layer can be measured by a method meeting JIS K7127. Specifically, a toner image receiving layer is formed by coating a material for the layer from 10 to 40 μm in thickness with a wire bar and drying the coating layer. A 5×70 mm strip is cut off as a sample from the toner image receiving layer. Breaking extension of the sample strip is measured under tension of 1 mm/min by Tensilon RTM-50 (which are manufactured by Orientec Co. Ltd.).

The thermoplastic resin for the toner image receiving layer 2 is of an aqueous type such as a water-soluble resin or a water-dispersant resin for the following reasons (i) and (ii):

(i) The aqueous type of resin spins off no organic solvent emission in the coating and drying process and, in consequence, excels at environmental adaptability and workability;

(ii) A release agent such as wax is hardly soluble in water at an ambient temperature in many instances and is often dispersed in a solvent such as water or an organic solvent prior to use. The water-dispersant type of resin is stable and excels at manufacturing process adaptability. In addition, wet or aqueous coating causes wax to easily bleed onto a surface during a coating and drying process, so as thereby to bring out effects of the release agent (offset resistance, adhesion resistance, etc.).

The aqueous resin is not always bounded by composition, bond-structure, molecular geometry, molecular weight, molecular weight distribution, etc. inasmuch as it is of a water-soluble type or a water-dispersant type. Preferred examples of the hydrophilic or the water-attracting group of polymer include a sulfonic acid group, a hydroxyl group, a carboxylic acid group, an amino group, an amid group, an ether group, etc.

Preferred examples of the water-soluble resin include those disclosed in Research Disclosure No. 17,643, page 26; No. 18,716, page 651; No. 307,105, pages 873-874; and Japanese Unexamined Patent Publication No. 64-13546, pages 71-75. More specifically, preferred examples of the water-soluble resin include a vinyl pyrrolidone acetate copolymer, a styrene-vinyl pyrrolidone copolymer, a styrene-maleic anhydride copolymer, water-soluble polyester, water-soluble acryl, water-soluble polyurethane, water-soluble nylon and water--soluble epoxy resin. Gelatin is selected from a group of lime-treated gelatin, acidized gelatin, what is called delimed gelatin that has a reduced lime content. These gelatin may be used individually or in any combination of two or more of them. Commercially available gelatins include various types of Pluscoat (which are manufactured by Gao Chemical Industry Co., Ltd.), various types of Fintex ES series (which are manufactured by Dainippon Ink & Chemical Inc.), both of which are of a water-soluble polyester; various types of Jurimar AT series (which are manufactured by Nippon Fine Chemical Co., Ltd.), Fintex 6161 and K-96 (which are manufactured by Dainippon Ink & Chemical Inc.), and Hyros NL-1189 and Hyros BH-997L (which are manufactured by Seiko Chemical Industry Co., Ltd.), all of which are of water-soluble acryl.

Preferred examples of the water-dispersant resin include a water-dispersant acrylic resin, a water-dispersant polyester resin, a water-dispersant polystyrene resin, a water-dispersant urethane resin, etc; emulsion such as an acryl resin emulsion, a polyvinyl acetate emulsion, an SBR (styrene-butadiene-rubber) emulsion or the like; and water-dispersed thermoplastic resins (a)˜(h) or emulsion of thermoplastic resins (a)˜(h). Otherwise, it is possible to use a copolymer of two or more of the thermoplastic resins (a)˜(h), a mixture of two or more of the thermoplastic resins (a)˜(h) or any one of the thermoplastic resins (a)˜(h) that are cation-modified.

(a) Resins having an ester bond;

(b) Polyurethane resins;

(c) Polyamide resins;

(d) Polysulfone resins;

(e) Polyvinylchloride resins;

(f) Polyvinyl butyral;

(g) Polycaprolactone resins;

(h) Polyolefin resins;

Specifically, preferred examples of (a) the resin having an ester bond include a polyester resin obtained resulting from condensation of a dicarboxylic acid component (which may be substituted with a sulfonic acid group or a carboxyl group) such as terephthalic acid, isophthalic acid, maleic acid, flumaric acid, phthalic acid, adipic acid, sebacic acid, azelaic acid, abietic acid, butanedioic acid, trimellitic acid or pyromellitic acid and an alcohol component (which may be substituted with a hydroxyl group) such as ethylele glycol, diethylene glycol, propylene glycol, bisphenol A, a dieter derivative of bisphenol A (which is, for example, bis-ethylene oxide adduct or bis-propylene oxide adduct), bisphenol S, 2-ethyle cyclohexyl dimethanol, neopentyl glycol, cyclohexyl dimethanol or glycerin; a polyacrylic ester resin or a polymethacrylic ester resin such as polymethyl methacrylate, polybutyl methacrylate, polymethyl acrylate or polybutyl acrylate; a polycarbonate resin; a polyvinyl acetate resin; a styrene acrylate resin; a styrene-methacrylic ester copolymer resin; a vinyl tolueneacrylate resin; etc. More specifically, examples include those disclosed in Japanese Unexamined Patent Publication Nos. 59-101395, 60-294862, 63-7971, 63-7972 and 63-7973.

Commercially available polyester resins include Vyron 103, Vyron 200, Vyron 280, Vyron 290, Vyron 300, Vyron GK-130 and Vyron GK-140 (which are manufactured by Toyobo Co., Ltd.); Tafuton NE-382, Tafuton U-5, Tafuton ATR-2009 and Tafuton ATR-2010 (which are manufactured by Kao Co., Ltd.); Elitel UE3500, Elitel UE3210 and Elitel XA-8153 (which are manufactured by Unitika Ltd.); Polyester TP-220 and Polyester R-188 (which are manufactured by Nippon Synthetic Chemical Industry Co., Ltd.); etc.

Commercially available acryl resins include Dianal SE-5437, Dianal SE-5102, Dianal SE-5377, Dianal SE-5649, Dianal SE-5466, Dianal SE-5482, Dianal HR-169, Dianal HR-124, Dianal HR-1127, Dianal HR-116, Dianal HR-113, Dianal HR-148, Dianal HR-131, Dianal HR-470, Dianal HR-634, Dianal HR-606, Dianal HR-607, Dianal LR-1065, Dianal LR-574, Dianal LR-143, Dianal LR-396, Dianal LR-637, Dianal LR-162, Dianal LR-469, Dianal LR-216, Dianal BR-50, Dianal BR-52, Dianal BR-60, Dianal BR-64, Dianal BR-73, Dianal BR-75, Dianal BR-77, Dianal BR-79, Dianal BR-80, Dianal BR-83, Dianal BR-85, Dianal BR-87, Dianal BR-88, Dianal BR-90, Dianal BR-93, Dianal BR-95, Dianal BR-100, Dianal BR-101, Dianal BR-102, Dianal BR-105, Dianal BR-106, Dianal BR-107, Dianal BR-108, Dianal BR-112, Dianal BR-113, Dianal BR-115, Dianal BR-116 and Dianal BR-117 (which are manufactured by Mitsubishi Rayon Co., Ltd.); Esrex P SE-0020, Esrex SE-0040, Esrex SE-0070, Esrex SE-0100, Esrex SE-1010 and Esrex SE-1035 (which are manufactured by Sekisui Chemical Co., Ltd.); Hymar ST95 and Hymar ST120 (which are manufactured by Sanyo Chemical Industry Co., Ltd.); and FM601 (which are manufactured by Mitsui Chemical Co., Ltd.).

Preferred examples of (e) the polyvinylchloride resin include a polyvinylden chloride resin, a vinyl chloride-vinyl acetate copolymer resin, a vinyl chloride-vinyl propionate copolymer resin or the like.

Preferred examples of (f) the polyvinyl butyral include a polyol resin, an ethyl cellulose resin, a cellulose resin such as a cellulose acetate resin, etc. These polyvinyl butyral have a polyvinyl butyral content greater than 70 weight % and an average degree of polymerization desirably higher than 500 and more desirably higher than 1000. Commercially available polyvinyl butyral include Denka Butyral 3000-1, Denka Butyral 4000-2, Denka Butyral 5000A and Denka Butyral 6000C (which are manufactured by Denki Kagaku Kogyo K.K.); Esrex BL-1, Esrex BL-2, Esrex BL-3, Esrex BL-S, Esrex BX-L, Esrex BM-1, Esrex BM-2, Esrex BM-5, Esrex BM-S, Esrex BH-3, Esrex BX-1 and Esrex BX-7 (which are manufactured by Sekisui Chemical Co., Ltd.); etc.

Preferred examples of (g) the polycaprolactone resin include a styrene-maleic anhydride resin, a polyacrylonitrile resin, a polyether resin, an epoxy resin, phenol resin, etc.

Preferred examples of (h) the polyolefm resin include a polyethylene resin, a polypropylene resin, a copolymer resin of olefin such as ethylene or propylene and a vinyl monomer, an acrylic resin, etc.

These thermoplastic resins may be used individually or in any combination of two or more thereof.

Commercially available water-dispersant resins include resins of Vyronal series (which are manufactured by Toyobo Co., Ltd.); resins of Pesuresin A series (which are manufactured by Takamatsu Oil & Fats Co., Ltd.); resins of Tafuton UE series (which are manufactured by Kao Co., Ltd.); resins of Polyester WR series (which are manufactured by Nippon Synthetic Chemical Industry Co., Ltd.) and resins of Eliel series (which are manufactured by Unitika Ltd.), all of which are of a polyester series, and resins of Hyros XE series, resins of KE series and resins of PE series (which are manufactured by Seiko Chemical Industry Co., Ltd.) and resins of Jurimar ET series (which are manufactured by Nippon Fine Chemical Co., Ltd.), all of which are of an acrylic series. It is desirable for the polymer to have a melt flow temperature (MFT) higher than an ambient temperature for storage before printing and lower than 100° C. for fixing toner.

For the thermoplastic resin used for the toner image receiving layer other than the water-soluble resins and the water-dispersant resins, it is preferred to use the same system of resin as the resin used as a binder for toner. Since a polyester resin, a styrene-acrylic ester copolymer, or a styrene-methacrylic ester copolymer is commonly used as toner, it is preferred to use a polyester resin, a styrene-acrylic ester copolymer, or a styrene-methacrylic ester copolymer as the thermoplastic resin for the electrophotographic image receiving sheet. More specifically, it is preferred for the electrophotographic image receiving sheet to contain a thermoplastic resin 20 weight % thereof. These compounds can be used individually, in a mixture of two or more of them or as a copolymer of them.

It is preferred that the thermoplastic resin for the toner image receiving layer has a molecular weight greater than a thermoplastic resin used for toner. However, according to the correlation between thermodynamic properties of these two thermoplastic resins for the toners and the toner image receiving layer, that relationship of molecular weight between them is not always preferred. For example, in the case where the thermoplastic resin for the toner image receiving layer has a melting temperature higher than the other, it is desirable for the resin for the toner image receiving layer to have the same molecular weight as the other or a molecular weight smaller than the other depending upon circumstances. It is also desirable to use a mixture of thermoplastic resins that have the same composition as each other but are different in average molecular weight from each other. The relationship of molecular weight between the thermoplastic resins for the toner and the toner image receiving layer is such as disclosed in Japanese Unexamined Patent Publication No. 8-334915.

It is preferred that the distribution of molecular weight of the thermoplastic resin for the toner image receiving layer is wider than that for the toner. It is desirable for the thermoplastic resin for the toner image receiving layer to satisfy solid state properties disclosed in, for example, Japanese Patent Publication No. 5-127413, Japanese Unexamined Patent Publication Nos. 8-194394, 8-334915, 8-334916, 9-171265 or 10-221877.

It is desirable for the thermoplastic resin to have a melt flow temperature (MFT) higher than an ambient temperature for storage before printing and lower than 100° C. for fixing toner. It is desirable for the toner image receiving layer to contain the thermoplastic resin in a range of from 10 weight % to 90 weight %, more desirably in a range of from 10 weight % to 70 weight %, and most desirably in a range of from 20 weight % to 60 weight %.

The toner image receiving layer may contain various other additives for the purpose of improving thermodynamic properties. Preferred examples of the additive include a plasticizing agent, a slip or release agent, a matting agent, a coloring agent, a filler, a crosslinking agent, an antistatic control agent, an emulsifying agent, a dispersing agent, etc.

Various conventional plasticizing agents can be used without any particular restrictions. The plasticizing agent has the function of controlling drift, softening or melting of the toner image receiving layer due to heat and/or pressure applied in the toner fixation process. The plasticizing agent can be selected consulting “Handbook Of Chemistry” by Chemical Society of Japan (published by Maruzen), “Plasticizer—Theory and Applications-” by Kouichi Murai (published by Koushobou), “Study On Plasticizer Vol. 1” and “Study On Plasticizer Vol. 2” both by Polymer Chemistry Association, “Handbook Rubber-Plastics Compounding Chemicals” by Rubber Digest Ltd., etc.

Available plasticizing agents are, on one hand, cited as high boiling point organic solvent or heat solvent and, on the other, listed in, for example, Japanese Unexamined Patent Publication Nos. 59-83154, 59-178451, 59-178453, 59-178454, 59-178455, 59-178457, 62-174745, 62-245253, 61-09444, 61-2000538, 62-8145, 62-9348, 62-30247, 62-136646, and 2-235694. Preferred examples of the plasticizing agent disclosed in these publications include a type of ester such as phthalate ester, phosphate ester, fatty ester, abietate, adipate, sebacate, azelate, benzoate, butyrate, epoxidized fatty ester, glycolate, propionate, trimellitate, citrate, sulfonate, calboxylate, succinate, maleate, phthalate or stearate; amide such as fatty amide or sulfoamide; ether; alcohol; lactone; and polyethyleneoxy.

Polymer having comparatively low molecular weights can be used as the plasticizing agent. When using such a polymer, it is preferred for the polymer to have a molecular weight less than a binder resin that is to be plasticized, appropriately less than 15000, and more appropriately less than 5000. In the case of using the polymer for the plasticizing agent, it is preferred for the polymer to be of the same type as a binder resin that is to be plasticized. For example, when plasticizing a polyester resin, it is preferred to use a polyester having a low molecular weight. Also, oligomer can be used for the plasticizing agent. Preferred examples of commercially available plastiizing agent other than the aforementioned compounds include Adecasizer PN-170 and Adecasizer PN-1430 (which are manufactured by Asahi Denka Kogyo K.K.); PARAPLEX-G-25, PARAPLEX-G-30 and PARAPLEX-G-40 (which are manufactured by HALL Corporation); and Estergum 8L-JA, Ester R-95, Pentaryn 4851, Pentaryn FK115, Pentaryn FK4820, Pentaryn FK830, Ruizol 28-JA, Picorastic A75, Picotex LC and Crystalex 3085 (which are manufactured by Rika Hercules Co., Ltd.).

It is possible to make arbitrary use of the plasticizing agent in order to reduce stress or strain (physical strain due to elastic force or viscosity or strain due to mass balance of molecules, main chains and pendants) that occurs when toner particles are buried in the toner image receiving layer. The plasticizing agent may be present in the toner image receiving layer in a microscopically dispersed state, a phase separated domain in micrometer size (like sea-island morphology) or a state where the plasticizing agent has mixed with and dissolved in other components such as a binder sufficiently.

It is preferred for the toner image receiving layer to contain a plasticizing agent in a range of from 0.001 weight % to 90 weight %, more preferably in a range of from 0.1 weight % to 60 weight %, and most preferably in a range of from 1 weight % to 40 weight %.

The plasticizing agent may be utilized for the purpose of optimizing competence to slip (improved sliding mobility due to a reduction in frictional force), offset of a fixing area (separation of a toner layer to the fixing area), a curling balance and static build-up (formation of electrostatic toner image).

The slip or release agent used as appropriate is added for the purpose of preventing the electrophotographic image receiving sheet from adhering to a heating member during fixing. Preferred examples of the slip or release agent include higher fatty acid, higher alcohol ester, Carbowax, higher alkylphosphate ester, silicon compounds, modified alcohol, hardened silicon, etc. Preferred examples of the slip or release agent that are desirably used include polyolefin wax, fluorinated oils, fluorinated wax, carnauba wax, microcrystal wax, silane compounds, etc. Further, there are a number of slip or release agents such as disclosed in U.S. Pat. Nos. 2,882,157, 3,121,060, 3,850,640, French paten No. 2,180,465, British patent Nos. 955,601, 1,143,118, 1,263,722, 1,270,578, 1,320,564, 1,320,757, 2,588,765, 1,739,891, 3,018,178, 3,042,522, 3,080,317, 3,082,087, 3,121,060, 3,222,178, 3,295,979, 3,489567, 3,5168,32, 3,658,573, 3,679,411, 3,870,521, Japanese Unexamined Patent Publication Nos. 49-5017, 51-14623, 54-159221, 56-81841, and Research Disclosure No. 13969.

It is desirable for the toner image receiving layer to contain the slip or release agent in a range of from 5 mg/m² to 500 mg/m², and more desirably in a range of from 10 mg/m² to 200 mg/m². In the case of an oil-less fixing process in which an oil is not used for the purpose of preventing the toner image receiving layer from offsetting to a fixing member, it is desirable for the toner image receiving layer to contain the slip or release agent in a range of from 30 mg/m² to 3000 mg/m², and more desirably in a range of from 100 mg/m² to 1500 mg/m². Since a wax type of slip or release agent is hard to dissolve in an organic solvent, it is preferred to prepare a water-dispersed slip or release agent mixed with a solution of a thermoplastic resin and coating the electrophotographic image receiving sheet with the mixture of the solution and the water-dispersed slip or release agent. In this instance, the wax type of slip or release agent disperses in the thermoplastic resin in the form of particulates. In this case, it is desirable for the toner image receiving layer to contain the slip or release agent in a range of from 5 mg/m² to 10000 mg/m², and more desirably in a range of from 5 mg/m² to 5000 mg/m².

Further Preferred examples of the slip or release agent include silicon compounds, fluorine compounds and wax.

Specifically, there are a number of the slip or release agents such as compounds disclosed in “Revised Edition: Property and Application of Wax” (published by Koushobou) and “Handbook Of Silicon” (published by Nikkan Kogyo Shinbun). There are a number of silicone compounds, fluorine compounds and wax suitably used for toner such as disclose in Japanese Patent Nos. 2,838,498 and 2,949,558; Japanese Patent Publication Nos. 59-38581 and 4-32380; Japanese Unexamined Patent Publication Nos. 50-117433, 52-52640, 57-148755, 61-62056, 61-62057, 61-118760, 2-42451, 3-41465, 4-212175, 4-214570, 4-263267, 5-34966, 5-119514, 6-59502, 6-161150, 6-175396, 6-219040, 6-230600, 6-295093, 7-36210, 7-43940, 7-56387, 7-56390, 7-64335, 7-199681, 7-223362, 7-287413, 8-184992, 8-227180, 8-248671, 8-2487799, 8-248801, 8-278663, 9-152739, 9-160278, 9-185181, 9-319139, 9-319413, 10-20549, 10-48889, 10-198069, 10-207116, 11-2917, 11-449669, 11-65156, 11-73049 and 11-194542. These compounds can be used individually or in combination of two or more.

Preferred examples of the silicone compound include a non-modified silicone oil such as a dimethyl siloxyane oil, a methyl hydrogen silicone oil or a phenylmetyl silicone oil (examples of commercially available non-modified silicone oil include KF-96, KF-96L, KF-96H, KF-99, KF-50, KF-54, KF-56, KF-965, KF-968, KF-994, KF-995, HIVAC, F-4, F-5 (which are manufactured by Shinetsu Chemical Industry Co., Ltd.), SH200, SH203, SH490, SH510, SH550, SH710, SH704, SH705, SH7028A, SH7036, SM7060, SM7001, SM7706, SM7036, SH871107, SH8627 (which are manufactured by Toray Dow Corning Silicone Co., Ltd.), TSF400, TSF401, TSF404, TSF405, TSF431, TSF433, TSF434, TSF437, TSF450, TSF451, TSF456, TSF458, TSF483, TSF484, TSF4045, TSF4300, TSF4600, YF-33, YF-3057 YF-3800, YF-3802 YF-3804, YF-3807, YF-3897, XF-3905, XS69-A1753, TEX100, TEX101, TEX102, TEX103, TEX104, TSW831 (which are manufactured by Toshiba Silicone Co., Ltd.)); an amino-modified silicone oil (examples of commercially available amino-modified silicone oil include KF-857, KF-858, KF-859, KF-861, KF-864 and KF-880 (which are manufactured by Shinetsu Chemical Industry Co., Ltd.), SF8417 and SM8709 (which are manufactured by Toray Dow Corning Silicone Co., Ltd.), and TSF4700, TSF4701, TSF4702, TSF4703, TSF4704, TSF4705, TSF4706, TEX150, TEX151 and TEX154 which are manufactured by Toshiba Silicone Co., Ltd.)); a carboxy-modified silicone oil (examples of commercially available carboxy-modified oil include BY-16-880 (which is manufactured by Toray Dow Corning Silicone Co., Ltd.) and TFS4770 and XF42-A9248 (which are manufactured by Toshiba Silicone Co., Ltd.)); a carbinol-modified silicone oil (examples of commercially available carbinol-modified silicone oil include XF42-B0970 (which is manufactured by Toshiba Silicone Co., Ltd.)); a vinyl-modified silicone oil (examples of commercially available vinyl-modified silicone oil include XF40-A1987 (which is manufactured by Toshiba Silicone Co., Ltd.)); an epoxy-modified silicone oil (examples of commercially available epoxy-modified silicone oil include SF8411 and SF8413 (which are manufactured by Toray Dow Coning Co., Ltd.) and TSF3965, TSF4730, TSF4732, XF42-A4439, XF42-A4438, XF42-A5041, XC96-A4462, XC96-A4462, XC96-A4463, XC96-A4464 and TEX170 (which are manufactured by Toshiba SiliconeCo., Ltd.)); a polyether-modified silicone oil (examples of commercially available polyether-modified silicone oil include KF-351(A), KF-352(A), KF-353(A), KF-354(A), KF-355(A), KF-615(A), KF-618(A) and KF-945(A) (which are manufactured by Shinetsu Chemical Industry Co., Ltd.), SH3746, SH3771, SH8421, SH8419, SH8400 and SH8410 (which are manufactured by Toray Dow Corning Silicone Co., Ltd.), and TSF4440, TSF4441, TSF4445, TSF4446, TSF4450, TSF4452, TSF4453 and TSF4460 (which are manufactured by Toshiba Silicone Co., Ltd.)); a silanol-modified silicone oil; a methacryl-modified silicone oil; a mercapto-modified silicone oil; an alcohol-modified silicone oil (examples of commercially available alcohol-modified silicone oil include SF8427 and SF8428 (which are manufactured by Toray Dow Corning Silicone Co., Ltd.) and TSF4750, TSF4751 and XF42-B0970 (which are manufactured by Toshiba Silicone Co., Ltd.)); an alkyl-modified silicone oil (examples of commercially available alkyl-modified silicone oil include SF8416 (which is manufactured by Toray Dow Corning Silicone Co., Ltd.) and TSF410, TSF411, TSF4420, TSF4421, TSF4422, TSF4450, XF42-334, XF42-A3160 and XF42-A3161 (which are manufactured by Toshiba Silicone Co., Ltd.)); a fluorine-modified silicone oil (examples of commercially available fluorine-modified silicone oil include SF1265 (which is manufactured by Toray Dow Corning Silicone Co., Ltd.) and FQF502 (which is manufactured by Toshiba Silicone Co., Ltd.)); silicone rubber or silicone particulates (examples of commercially available silicone rubber or silicone particulates include SH851U, SH745U, SH55UA, SE4705U, SH502UA&B, SRX539U, SE6770-P, DY38-038, DY38-047, Trefil F-201, Trefil F-202, Trefil F-250, Trefil R-900, Trefil R902A, Trefil E-500, Trefil E-600, Trefil E-601, Trefil E-506 and Trefil BY29-119 (which are manufactured by Toray Dow Corning Silicone Co., Ltd.) and Tospal 105, Tospal 120, Tospal 130, Tospal 145, Tospal 250 and Tospal 3120 (which are manufactured by Toshiba Silicone Co., Ltd.)); a silicone-modified compound of a silicone resin such as an olefin resin, a polyester resin, a vinyl resin, a polyamide resin, a cellulose resin, a phenoxy resin, a vinyl chloride-vinyl acetate resin, an urethane resin, an acryl resin, a styrene-acryl resin and copolymers of these resins (examples of commercially available silicone-modified compounds include Dialoma SP203, Dialoma SP712, Dialoma SP2105 and Dialoma SP2023 (which are manufactured by Dainichiseika Color & Chemicals Mfg. Co., Ltd.), Modipa FS700, Modipa FS710, Modipa FS720, Modipa FS730 and Modipa FS770 (which are manufactured by Nippon Oils & Fats Co., Ltd.), Saimack US-270, Saimack US-350, Saimack US-352, Saimack US-380, Saimack US-413, Saimack US-450, Rezeda GP-705, Rezeda GS-30, Rezeda GF-150 and Rezeda GF-300 (which are manufactured by Toa Gosei Chemical Industry Co., Ltd.), SH997, SR2114, SH2104, SR2115, SR2202, DCI-2577, SR2317, SE4001U, SRX625B, SRX643, SRX439U, SRX488U, SH804, SH840, SR2107 and SR2115 (which are manufactured by Toray Dow Corning Silicone Co., Ltd.), and YR3370, TSR1122, TSR102, TSR108, TSR116, TSR117, TSR125A, TSR127B, TSR144, TSR180, TSR187, YR47, YR3187, YR3224, YR3232, YR3270, YR3286, YR3340, YR3365, TEX152, TX153, TEX171 and TEX172 (which are manufactured by Toshiba Silicone Co., Ltd.)); and a reactive silicone compound such as an addition reaction type reactive silicone compound, a peroxide curing type reactive silicone compound or an ultraviolet curing type reactive silicone compound (examples of commercially available reactive silicone compounds include TSR1500, TSR1510, TSR1511, TSR1515, TSR1520, YR3286, YR3340, PSA6574, TPR6500, TPR6501, TPR6600, TPR6702, TPR6604, TPR6701, TPR6705, TPR6707, TPR6708, TPR6710, TPR6712, TPR6721, TPR6722, UV9315, UV9425, UV9430, XS56-A2775, XS56-A2982, XS56-A3075, XS56-A3969, XS56-A5730, XS56-A8012, XS56-B1794, SL6100, SM3000, SM3030, SM3200 and YSR3022 (which are manufactured by Toshiba Silicone Co., Ltd.).

Preferred examples of the fluorine compound include a fluorine oil (examples of commercially available fluorine oil include Dyfloyl #1, Dyfloyl #3, Dyfloyl #10, Dyfloyl #20, Dyfloyl #50, Dyfloyl #100, Unidyn TG-440, Unidyn TG-440, Unidyn TG452, Unidyn TG490, Unidyn TG-560, Unidyn TG-561, Unidyn TG-590, Unidyn TG-652, Unidyn TG-670U, Unidyn TG-991, Unidyn TG-999, Unidyn TG-3010, Unidyn TG-3020 and Unidyn TG-3510 (which are manufactured by Daikin Kogyo Co., Ltd.), MF-100, MF-110, MF-120, MF-130, MF-160 and MF-160E (which are manufactured by Tokem Products Co., Ltd.), Surflon S-111, Surflon S-112, Surflon S-113, Surflon S-121, Surflon S-131, Surflon S-132, Surflon S-141 and Surflon S-145 (which are manufactured by Asahi Glass Co., Ltd.) and FC-430 and FC431 (which are manufactured by Mitsui Phluoro Chemicals Co., Ltd.)); fluorine rubber (examples of commercially available fluorine rubber include LS63U (which is manufactured by Toray Dow Corning Silicone Co., Ltd.)); a fluorine-modified resin (examples of commercially available fluorine-modified resin include Modipa F200, Modipa F220, Modipa F600, Modipa F2020 and Modipa F3035 (which are manufactured by Nippon Oils & Fats Co., Ltd.), Dialoma FF203 and Dialoma FF204 (which are manufactured by Dainichiseika Color & Chemicals Mfg. Co., Ltd.), Surflon S-381, Surflon S-383, Surflon S-393, Surflon SC-101, Surflon SC-105, Surflon KH-40 and Surflon SA-100 (which are manufactured by Asahi Glass Co., Ltd.), EF-351, EF-352, EF-801, EF-802, EF-601, TFE, TFEMA and PDFOH (which are manufactured by Tokem Products Co., Ltd., and THV-200P (which is manufactured by Sumitomo 3M Ltd.)); a fluorosulfonate compound (examples of commercially available fluorosulfonate compound include EF-101, EF-102, EF-103, EF-104, EF-105, EF-112, EF-121, EF122A, EF122B, EF-122C, EF-123A, EF-123B, EF-125M, EF-132, EF-135M, EF-305, FBSA, KFBS and LFBS (which are manufactured by Tokem Products Co., Ltd.)); a fluorosulfonic acid; a fluoride compound or its salt (e.g. an anhydrous fluoric acid, a dilute fluoric acid, a fluorobolic acid, zinc fluorobolite, nickel fluorobolate, tin fluorobolite, lead fluorobolite, cupric fluorobolate, a hydrofluosilicic acid, potassium titanate fluoride, a perfluoro caprylic acid, perfluoro ammonium octanate, etc.); and inorganic fluoride (e.g. aluminium floride, potassium silicofluoride, potassium zirconate fluoride, zinc fluoride tetrahydrate, potassium fluoride, lithium fluoride, barium fluoride, tin fluoride, potassium fluoride, acidic potassium fluoride, magnesium fluoride, titanic fluorid, ammonium phosphate hexafluoride, potassium phosphate hexafluoride, etc.).

Preferred examples of the wax include paraffin wax (examples of commercially available paraffin wax include Paraffin Wax 155, 150, 140, 135, 130, 125, 120, 115, NHP-3, NHP-5, NHP-9, NHP-10, NHP-11, NHP-12, NHP-15C, SP-0160, SP-0145, SP-1040, SP-1035, SP-3040, SP-3035, NPS-8070, NPS-L-70, OX-2151, OX2251, EMUSTAR-0384 and EMUSTAR-0136 (which are manufactured by Nippon Seiro Co., Ltd.), Serozole 686, 651-A, A, H-803, B-460, E-172, 866, K-133, Hidrin D-337 and E-139 (which are manufactured by Chukyo Oils & Fats Co., Ltd.), 125° Paraffin, 125° FP Paraffin, and 130° Paraffin, 135° Paraffin, 135° H Paraffin, 140° Paraffin, 140° N Paraffin, 145° Paraffin and Paraffin Wax M (which are manufactured by Nisseki Mitsubishi Oil Co., Ltd.)); microcrystalline wax (examples of commercially available microcrystalline wax include Hi-Mic-2095, Hi-Mic-3090, Hi-Mic-1080, Hi-Mic-1070, Hi-Mic-2065, Hi-Mic-1045, Hi-Mic-2045, EMUSTAR-0001 or EMUSTAR-042X (which are manufactured by Nippon Seiro Co., Ltd.), Serozole 967 and M (which are manufactured by Chukyo Oils & Fats Co., Ltd.), 155 Microwax and 180 Microwax (which are manufactured by Nisseki Mitsubishi Oil Co., Ltd.)); petrolatum (examples of commercially available petrolatum include OX-1749, OX-0450, OX-0650B, OX-0153, OX-261BN, OX-0851, OX-0550, OX-0750B, JP-1500, JP-056R and JP-011P (which are manufactured by Nippon Seiro Co., Ltd.)); Fischer-Tropsch wax (examples of commercially available Fischer-Tropsch wax include FT-100 and FT-0070 (which are manufactured by Nippon Seiro Co., Ltd.)); an acid amide compound or an acid imide compound such as amide stearate or imide phthalic anhydride (examples of commercially available amide stearate or imide phthalic anhydride include Serozole 920, Serozole B-495, Himicron G-270, Himicron G-110 and Hidrin D-757 (which are manufacture by Chukyo Oils & Fats Co.)); and modified wax such as amine-modified polypropylene (e.g. QN-7700 (which is manufactured by Sanyo Chemical Industry Co., Ltd.)), acrylic acid-modified wax, fluorine-modified wax or olefin-modified wax; urethane type wax (examples of urethane type wax include NPS-6010 and HAD-5090 (which are manufactured by Nippon Seiro Co., Ltd.)); and alcohol type wax (examples of alcohol type wax include NPS-9210, NPS-9215, OX-1949 and XO-020T (which are manufactured by Nippon Seiro Co., Ltd.)).

Preferred examples of the hydrowax include hydrogenerated ricinus oil (e.g. Castor Wax which is manufactured by Ito Oil Manufacturing Co., Ltd.)); derivatives of ricinus oil (examples of commercially available derivatives include dehydrated risinus oil DCO, DCO Z-1, DCO-Z2, risinus oil fatty acid CO-FA, ricinoleic acid, dehydrated risinus oil fatty acid DCO-FA, dehydrated risinus oil fatty acid epoxyester D-4 ester, risinus oil urethane acrylate CA-10, CA-20, CA-30, derivatives of risinus oil MINERASOL S-74, MINERASOL S-80, MINERASOL S-203, MINERASOL S-42X, MINERASOL RC-17, MINERASOL RC-55, MINERASOL RC-335, special risinus oil condensed fatty acid MINERASOL RC-2, MINERASOL RC-17, MINERASOL RC-55, MINERASOL RC-335, special risinus oil condensed fatty acid ester MINERASOL LB-601, MINERASOL LB-603, MINERASOL LB-604, MINERASOL LB-7-2, MINERASOL LB-703, MINERASOL #11 and MINERASOL L164 which are manufactured by Ito Oil Manufacturing Co., Ltd.); stearic acid (e.g. 12-hydroxystearic acid which is manufactured by Ito Oil Manufacturing Co., Ltd.)); lauric acid; myristic acid; palmitic acid; behenic acid; sebacic acid (e.g sebacic acid which is manufactured by Ito Oil Manufacturing Co., Ltd.)); undecylenic acid (e.g. undecylenic acid which is manufactured by Ito Oil Manufacturing Co., Ltd.)); heptyl acid (e.g. heptyl acid which is manufactured by Ito Oil Manufacturing Co., Ltd.)); maleic acid; higher maleic oil (examples of higher maleic oil include HIMALEIN DC-15, HIMALEIN LN-10, HIMALEIN 00-15, HIMALEIN DF-20 and HIMALEIN SF-20 (which are manufactured by Ito Oil Manufacturing Co., Ltd.)); blown oil (examples of blown oil include Serbonol #10, Serbonol #30, Serbonol #60, Serbonol R-40 and Serbonol S-7 (which are manufactured by Ito Oil Manufacturing Co., Ltd.)); and cyclopentadiene oil (examples of cyclopentadiene oil include CP Oil and CP Oil-S (which are manufactured by Ito Oil Manufacturing Co., Ltd.)).

Preferred natural wax is at least one of vegetable wax, animal wax and mineral wax. The vegetable wax is especially preferred among them. In light of compatibility in the case where an aqueous thermoplastic resin is used for the toner image receiving layer 2, it is more desirable to employ water-dispersant natural wax.

Preferred examples of the vegetable wax include carnauba wax (e.g. examples of commercially available carnauba wax include EMUSTAR-0413 (which is manufactured by Ito Oil Manufacturing Co., Ltd.) and Serozole 524 (which is manufactured by Chukyo Oils & Fats Co., Ltd.)), castor oil (e.g. castor oil manufactured by Ito Oil Manufacturing Co.), colza oils, soybean oils, sumac wax, cotton wax, rice wax, sugarcane wax, canderyla wax, Japan wax and jojoba oil.

Preferred examples of the animal wax include bees wax, lanolin, spermaceti wax, blubber oil and wool wax. The carnauba wax having a melting temperature in a range of from 70° C. to 95° C., is especially preferred among them in terms of preeminence in offset resistance, adhesion resistance, pass-though capability in passing though electrophotographic equipments, feeling of glossiness, toughness against cracks as well as from the viewpoint that the electrophotographic image receiving sheet is capable of forming a high quality image.

Preferred examples of the mineral wax include natural wax such as montan wax, montan ester wax, ozokerite or ceresin; fatty acid ester (examples of commercially available fatty acid ester include Sensosizer DOA, Sensosizer AN-800, Sensosizer DINA, Sensosizer DIDA, Sensosizer DOZ, Sensosizer DOS, Sensosizer TOTM, Sensosizer TITM, Sensosizer E-PS, Sensosizer nE-PS, Sensosizer E-PO, Sensosizer E4030, Sensosizer E-6000, Sensosizer E-2000H, Sensosizer E-900OH, Sensosizer TCP and Sensosizer C-1100 (which are commercially available manufactured by Chukyo Oils & Fats Co., Ltd.)); a synthetic hydrocarbon such as polyethylene wax (examples of commercially available polyethylene wax include Polyron A, Polyron 393 and Polyron H-481 (which are manufactured by Chukyo Oils & Fats Co., Ltd.) and Sunwax E-310, Sunwax E-330, Sunwax E-250P, Sunwax LEL-250, Sunwax LEL-800 and Sunwax LEL-400P (which are manufactured by Sanyo Chemical Industry Co. Ltd.)); and polypropylene wax (examples of commercially available polypropylene wax include Viscol 330-P, Viscol 550-P and Viscol 660-P (which are manufactured by Sanyo Chemical Industry Co., Ltd.)). The montan wax having a melting temperature in a range of from 70° C. to 95° C. is especially preferred among them in terms of preeminence in offset resistance, adhesion resistance, capability in passing through electrophotographic equipments, feeling of glossiness, toughness against cracks as well as from the viewpoint that the electrophotographic image receiving sheet is capable of forming a high quality image.

The natural wax content of the toner image receiving layer (surface) is in a range of desirably from 0.1 to 4 g/m², and more desirably in a range of from 0.2 to 2 g/m². If the natural wax content exceeds 0.1 g/m², significant deterioration of, in particular, offset resistance and adhesion resistance will occur. On the other hand, if the natural wax content exceeds 4 g/m², the amount of wax is too much to form a high quality of image. It is desirable for the natural wax to have a melting temperature din a range of from 70 to 95° C., and more desirably in a range of from 75 to 90° C. in light of, in particular, offset resistance and capability in passing through electrophotographic equipments.

The slip or release agent that is added into the toner image receiving layer as appropriate may be derivatives of the materials mentioned above, oxides of the materials mentioned above, refined particles o of the materials mentioned above, or mixtures of the materials mentioned above. These materials may have reactive substituents.

It is preferred for the toner image receiving layer to contain a slip or release agent desirably in a range of from 0.1 to and 10 weight %, more desirably in a range of from 0.3 to 8.0 weight %, and most desirably from 0.5 to 5.0 weight %. Further, in the case of employing an oil-less fixing process in which an oil is not used for the purpose of preventing the toner image receiving layer from offsetting to a fixing member, it is preferred for the toner image receiving layer to contain a slip or release agent in a range of from 30 mg/m² to 3000 mg/m², and more desirably in a range of from 100 mg/m² to 1500 mg/m².

The matting agent is added to the toner image receiving layer for the purpose of preventing electrophotographic image receiving sheets from clinging to each other and preventing an electrophotographic image receiving sheet from jamming in an electrophotographic machine. Materials conventionally used as a matting agent are utilized. Solid particles used for the matting agent are classified into two types, namely an inorganic particle and an organic particle. Examples of the inorganic matting particle include oxides (e.g. a silica dioxide, a titanium oxide, a magnesium oxide and an aluminum oxide), alkaline earth metal salts (e.g. barium sulfate, calcium carbonate and magnesium sulfate), silver halides (e.g. a silver chloride and silver bromide), and glass.

Preferred examples of the inorganic matting agent include those such as disclose in West Germany patent No. 2,529,321, British patent Nos. 760775 and 1,260,772, U.S. Pat. Nos. 1,201,905, 2,192,241, 3,053,662, 3,062,649, 3,257,206, 3,322,555, 3,353,958, 3,370,951, 3,411,907, 3,437,484, 3,523,022, 3,615,554, 3,635,714, 3,769,020, 4,021,245 and 4,029,504.

Preferred examples of the organic matting agent include starch, cellulose ester (e.g. cellulose acetate propionate), cellulose ether (e.g. ethyl cellulose), and synthetic resins. The synthetic resin is desirably of a water-insoluble type or of a hardly soluble type. Examples of the synthetic resins include poly(meth)acrylic ester (e.g. polyalkyl acrylate, polyalkyl(meth)--acrylate, polyalkoxyalkyl(meth) acrylate, polyglycidyl(meth) acrylate), poly(meth)acrylamide, polyvinyl ester (e.g. polyvinyl acetate), polyacrylonitrile, polyolefin (e.g. polyethylene), polystyrene, a benzoguanamine resin, a formaldehyde condensed polymer, an epoxy resin, polyamide, polycarbonate, a phenol resin, polyvinyl carbazole, and polyvinyliden chloride. Copolymers comprising monomers used for the above mentioned polymers may be use.

In the case of utilizing the copolymer, the copolymer may contain a small chain of hydrophilic repeating units. Preferred examples of the a monomer forming a hydrophilic repeating unit include acrylic acid, methacrylic acid, α β-unsaturated carboxylic acid, hydroxyalkyl(meth)acrylate, sulfoalkyl(meth)acrylate and styrene sulfonate.

Specifically, there are a number of available organic matting agents such as described in British Patent No. 1,055,713, U.S. Pat. Nos. 1,939,213, 2,221,873, 2,268,662, 2,322,037, 2,376,005, 2391,181, 2,701,245, 2,992,101, 3,079,257, 3,262,782, 3,443,946, 3,516,832, 3,539,344, 3,591,397, 3,754,924 and 3,767,448, and Japanese Unexamined Patent Publication Nos. 49-106821 and 57-14835. These solid particles may be used individually or in any combination of two or more. The average particle size is preferably in a range of from 1 to 100 μm, and more desirably in a range of from 4 to 30 μm. The amount of used solid particles is desirably in a range of from 0.01 to 0.5 g/cm², and more properly in a range of from 0.02 to 0.3 g/cm².

Preferred examples of the coloring agent include fluorescent brightening agents, white pigment, colored pigment, dye, etc. The fluorescent brightening agent is a compound having absorptive power in a near-ultraviolet range and generates fluorescence in a range of from 400 to 500 nm. There are a number of conventional fluorescent coloring agents can be used without being particularly bounded by types. Preferred examples of the fluorescent brightening agent include compounds such as disclosed in “The Chemistry of Synthetic Dyes” by K. VeenRatarman, Vol. 8, Chapter 8. Specifically, the compounds include stilbene compounds, coumarin compounds, biphenyl compounds, benzooxazoline compounds, naphthalimide compounds, pylazorine compounds, carbostyryl compounds, etc. Preferred examples of commercially available fluorescent brightening agent include White Fulfa PSN, White Fulfa PHR, White Fulfa HCS, White Fulfa PCS and White Fulfa B which are manufactured by Sumitomo Chemical Co., Ltd., and UVITEX-OB manufactured by Chiba-Geigy Ltd.

Preferred example of white pigment is inorganic pigments (e.g. a titanium oxide, calcium carbonate, etc.) that will be listed in connection with fillers later. Preferred examples of the colored pigment include various pigments and azoic pigment disclosed in, for example, Japanese Unexamined Patent Publication No. 63-44653 (e.g. azolake pigment such as carmine 6B or red 2B, insoluble azo pigment such as monoazo yellow, disazo yellow, pyrazolo orange or Balkan orange, condensed azo pigment such as chromophthal yellow or chromophthal red); polycyclic pigment (e.g. phthalocyanine pigment such as copper phthalocyanine. blue or copper phthalocyanine green, dioxazine pigment such as dioxazine violet, isoindolynone pigment such as indolynone yellow, slen pigment such as perylene, perynon, flavantron or thioindigo); lake pigment (e.g. malachite green, rhodamine B, rhodamine G and Victoria blue B); and inorganic pigment (e.g. an oxide, a titanium dioxide, colcothar, sulfate such as precipitated barium sulfate, carbonate such as precipitated calcium carbonate, silicate such as hydrated silicate or anhydrous silicate, metal powder such as aluminum powder, bronze powder, blue powder, carbon black, chrom yellow, iron blue or the like. These organic pigments may be used individually or in any combination of two or more. The titanium oxide is the most preferable pigment among them. The pigments are not particularly bound by shape and are, however, desirable to comprise hollow particles in light of predominant thermal conductivity (low thermal conductivity) during toner image fixation.

Various oil-soluble dyes and water-insoluble dyes that have been conventionally used as the coloring agent are utilized. Preferred examples of the oil-soluble dye include anthraquinone compounds and azo compounds.

Preferred examples of the water-insoluble dye include vat dye such as C.I. Vat violet 1, C.I. Vat violet 2, C.I. Vat violet 9, C.I. Vat violet 13, C.I. Vat violet 21, C.I. Vat blue 1, C.I. Vat blue 3, C.I. Vat blue 4, C.I. Vat blue 6, C.I. Vat blue 14, C.I. Vat blue 20 or C.I. Vat blue 35; disperse dye such as C.I. disperse violet 1, C.I. disperse violet 4, C.I. disperse violet 10, C.I. disperse blue 3, C.I. disperse blue 7 or C.I. disperse blue 58; and oil-soluble dye such as C.I. solvent violet 13, C.I. solvent violet 14, C.I. solvent violet 21, C.I. solvent violet 27, C.I. solvent blue 11, C.I. solvent blue 12, C.I. solvent blue 25 or C.I. solvent blue 55. Colored couplers used for silver photography can be preferably utilized.

It is preferred for the toner image receiving layer (surface) to contain a coloring agent in a range of from 0.1 to 8 g/cm², and more desirably in a range of from 0.5 to 5 g/cm². If the coloring agent content is less than the lower limit of 0.1 g/cm², the toner image receiving layer has an increased light transmittance. On the other hand, if the coloring agent content is beyond the upper limit of 8 g/cm², the toner image receiving layer is apt to become poor in tractability or to looses adhesion resistance and toughness against cracks. It is desirable for the toner image receiving layer to have a pigment content less than 40 weight %, more desirably less than 30 weight %, and most desirably less than 20 weight %, according to the weight of a thermoplastic resin forming the toner image receiving layer.

Preferred examples o filler for the toner image receiving layer include organic fillers and inorganic fillers (or pigment) that have been known as stiffener for a binder resin, a loading material or a reinforcing material. The filler can be selected consulting “Handbook: Rubber-Plastics Composing Chemicals” (Rubber Digest Ltd.), “New Edition Plastic Composing Chemicals—Fundamentals And Applications” (Taiseisha), or “Filler Handbook” (Taiseisha).

Preferred examples of the inorganic filler (or pigment) include silica, alumina, a titanium dioxide, a zinc oxide, a zirconium oxide, an iron oxide like mica, zinc white, a lead oxide, a cobalt oxide, strontium chromate, molybdenum pigments, smectite, a magnesium oxide, a calcium oxide, a calcium carbonate, mullite, etc. Silica or alumina is particularly preferable as the filler among them. These fillers may be used individually or in combination of two or more. The filler desirably comprises particulates. If the size of filler particle is large, the toner image receiving layer is apt to have a rough surface.

There are two types of silica, i.e. globular silica and amorphous silica. These silica can be synthesized in either a wet process, a dry process or an aerogel process. Surfaces of hydrophobic silica particles may be treated with a trimethylsilyl group or silicon. In this case, it is preferred to use colloidal silica particles. It is desirable for the silica particles to have an average particle size in a range of from 4 to 120 nm, and more desirably in a range of from 4 to 90 nm. Further, it is desirable for the silica particles to be porous. It is desirable for the porous silica particles to have an average particle size in a range of from 50 to 500 nm, and an average pour volume per unit mass in a range of from 0.5 to 3 ml/g.

There are two types of alumina, i.e. anhydrous alumina and alumina hydrate that are used for the filler. The anhydrous alumina may be of a crystal form of α, β, γ, δ, ζ, η, θ, κ, ρ or χ. The anhydrous alumina is desirably used rather than the alumina hydrate. Examples of the alumina hydrate are monohydrate such as pseudoboemite, boemite or diaspore and trihydrate such as gibbsite or bayerite. It is preferred for the alumina particle to have an average particle size in a range of from 4 to 300 nm, and more desirably in a range of from 4 to 200 nm, and is also preferred to be porous. It is preferred for the porous alumina particles to have an average particle size in a range of from 50 to 500 nm and an average pour volume per unit mass in a range of from 0.3 to 3 ml/g.

The alumina hydrate can be synthesized in either a sol-gel process in which alumina is precipitated by adding ammonia in a solution of alminium or a hydrolysis process in which an aluminate alkali is hydrolyzed. The anhydrous alumina can be derived by heating alumina hydrate for dehydration.

It is preferred for the filler to be added in a range of from 5 to 2000 weight % according to a dried weight of a binder of a layer to which the filler is added.

The crosslinking agent is added for the purpose of providing the toner image receiving layer with storage stability and adjusting thermoplasticity of the toner image receiving layer. Compounds used for such a crosslinking agent are those that have more than two reactive groups such as an epoxy group, an isocyanate group, an aldehydo group, an active halogen group, an active methylene group, an acetylene group or others conventionally well known, in a molecule. In addition, it is effective to use compounds that have more than two groups capable of forming a bond through an ionic bond, a hydrogen bonding, a coordinate bonding, etc.

Preferred examples of the crosslinking agent include conventionally known compounds such as a coupling agent, a hardening agent, a polymerization initiator, a polymerization promoter, a coagulating agent, a film forming agent, a film forming auxiliary agent ort he like for resins. There are number of coupling agents such as chlorosilane, vinylsilane, epoxysilane, aminosilane, alkoxy aluminum chelate, titanate coupling agent or those disclosed in “Handbook: Rubber-Plastics Composing Chemicals” (Rubber Digest Ltd.).

It is preferred for the toner image receiving layer to contain an antistatic or charge adjusting agent for the purpose of controlling toner transfer and toner adhesion and preventing toner image receiving layers from adhering to each other due to charges.

Materials that have conventionally been known as a charge adjusting agent can be used. Examples of the charge adjusting agent include, but not limited to, surface-active agents, polyelectrolyte and electrconductive metal oxides. Examples of the charge adjusting agent include cation antistatic agents such as a quaternary ammonium salt, a polyamine derivative, cation-modified polymethyl methacrylate or cation-modified polystyrene; anionic antistatic agents such as alkylphosphate or anion polymers; and nonionic antistatic agents such fatty ester or polyethylene oxides. In the case where toner is charged with negative electricity, the cation antistatic agent or the nonionic antistatic agent is especially preferred among them.

Preferred examples of the electroconductive metal oxide include ZnO, TiO₂, SnO₂, Al₂O₃, In₂O₃, SiO₂, MgO, BaO, MoO₃, etc. These electroconductive metal oxides may be used individually or in the form of complex oxide of them. The metal oxide may be further doped with a hetero element. For example, ZnO may be doped with Al or In; TiO₂ may be doped with Nb or Ta; and SnO₂ may be doped with Sb, Nb or halogens.

It is preferred for the toner image receiving layer to contain various additives for the purpose of improving stability of an image formed on the electrophotographic image receiving sheet and stability of the image receiving layer. In order to accomplish the purpose, preferred examples of the additive include an antioxidant, an antidegeneration agent, an antidegradation agent, antiozonant, an ultraviolet absorption agent, an metal complex, a light stabilizer, an antiseptic agent and a fungicide which are well known in the art.

Examples of the antioxidant include chroman compounds, cumarin compounds, phenolic compounds (e.g. hindered phenol), hydroquinone derivatives, hindered amine derivatives, spiroindan compounds, etc. The antioxidants that are disclosed in, for example, Japanese Unexamined Patent Publication No. 61-159644 can be use.

The antidegeneration agent can be selected consulting “Handbook: Rubber-Plastics Composing Chemicals 2^{nd} Revised Edition” (1993, Rubber Digest Ltd.), pages from 76 to 121.

Examples of the ultraviolet absorption agent include benzotriazole compounds such as disclosed in U.S. Pat. No. 3,533,794, 4-thiazolidine compounds such as disclosed in U.S. Pat. No. 3,352,681, benzophenone compounds such as disclosed in Japanese Unexamined Patent Publication No. 46-2784, and ultraviolet absorption polymers such as disclosed in Japanese Unexamined Patent Publication No. 62-260152.

Examples of the metal complex are those disclosed in, for example, U.S. Pat. Nos. 4,241,155, 4,245,018 and 4,254,195, Japanese Unexamined Patent Publication Nos. 61-88256, 62-174741, 63-199428, 1-75568 and 1-74272, and ultraviolet absorption agents and light stabilizers that are listed in “Handbook: Rubber-Plastics Composing Chemicals 2^{nd} Revised Edition” (1993, Rubber Digest Ltd.), pages from 122 to 137.

Additives well known in the conventional photographic art can be used for the toner image receiving layer. Examples of the additive includes those disclosed in Research Disclosure Magazine Nos. 17643 (December 1987), 18716 (November 1979) and 307105 (November 1989). These additives appear on the following pages:

| | | | RD |
|---|---|---|---|
| Additive | RD No. 17643 | RD No. 18716 | No. 307105 |
| Brightener | 24 | 648R | 868 |
| Stabilizer | 24-25 | 649R | 868-870 |
| Light Absorbent | 25-26 | 649R | 873 |
| (UV Absorbent) | | | |
| Color Image Stabilizer | 25 | 650R | 872 |
| Film Hardener | 26 | 651L | 874-875 |
| Binder | 26 | 651L | 873-874 |
| Plasticizer/Lubricant | 27 | 650R | 876 |
| Coating Auxiliary | 26-27 | 650R | 875-876 |
| (Surface-active agent) | | | |
| Antistatic Agent | 27 | 650R | 976-977 |
| Matting Agent | | | 878-879 |

The toner image receiving layer is formed by applying a coating liquid containing a polymer over the substrate sheet with a wire coater and drying. The coating liquid is prepared by, for example, dissolving or uniformly dispersing additives, e.g. a thermoplastic polymer and a plasticizing agent, in an organic solvent such as alcohol or ketone. Preferred examples of the organic solvent include methanol, isopropyl alcohol and methyl ethyl ketone. In the case of using a water-soluble polymer for the toner image receiving layer, the toner image receiving layer can be formed by applying an aqueous solution of the polymer over the substrate sheet. On the other hand, in the case of using a water-insoluble polymer, the toner image receiving layer can be formed by applying a water-dispersed solution of the polymer over the substrate sheet.

It is preferred for the polymer layer to have a melt flow temperature higher than an ambient temperature for storage before printing and lower than 100° C. for toner particle fixation. Further, it is preferred for the toner image receiving layer to have a dried weight in a range of from 1 to 20 g/m² and more desirably in a range of from 4 to 15 g/m², and a dried thickness in a range of from 1 to 30 μm, and more desirably in a range of from 2 to 20 μm.

The following description will be directed to solid state properties of the toner image receiving sheet. It is preferred to have the following solid state properties relative to whiteness, glossiness and smoothness in addition to the necessity of having breaking extension greater than 0.2% as was previously described.

It is preferred for the toner image receiving layer to have a high degree of whiteness, specifically, higher than 85% when estimated by the measuring method meeting JIS 8123. Further, it is preferred for the toner image receiving layer to have a spectral reflection coefficient higher than 85% and a difference between the highest and the lowest spectral reflection coefficients less than 5% in a wavelength range of from 440 to 640 nm and a spectral reflection coefficient higher than 85% and a difference between the highest and the lowest spectral reflection coefficients less than 8% in a wavelength range of from 400 to 700 nm.

More specifically, when specifying the degree of whiteness expressed in CIE 1976 (L*a*b*) color space, it is preferred the toner image receiving layer to have an L* value greater than 80, more desirably greater than 85 and most desirably greater than 90. The white tint is desirable as neutral as possible and, in other words, has a value ((a*)²+(b*)²) expressed in CIE 1976 (L*a*b*) color space less than 50, more desirably less than 18 and most desirably less than 5.

It is preferred for the toner image receiving layer to have a high degree of glossiness, specifically, a degree of 45° glossiness greater than 60, more desirably greater than 75, and most desirably greater than 90, in a range of from a white state (which refers to a state where no toner is applied to the image receiving layer) to a black state (which refers a state where toner is applied to the image receiving layer at the highest density. However, the highest degree of 45° glossiness is desirably less than 110 in the same range. If the degree of 45° glossiness is beyond 110, the toner image receiving layer forms an image with a gloss like metallic luster which is undesirable in image quality. The degree of glossiness can be estimated by the measuring method meeting JIS Z8741.

It is preferred for the toner image receiving layer to have a high degree of smoothness, specifically, arithmetic mean roughness (Ra) less than 3 μm, more desirably less than 1 μm, and most desirably less than 0.5 μm in a range of from the white state to the black state. The arithmetic mean roughness (Ra) can be estimated by the measuring method meeting JIS B0601, B0651 and B0652.

It is further preferred for the toner image receiving layer to satisfy at least one, more desirably two or more, of the following solid state properties (1) to (8):

(1) The toner image receiving layer has a glass-transition temperature (Tg) desirably higher than 30° C., but within +20° C. from a glass-transition temperature of toner

(2) The toner image receiving layer has a ½ melting temperature (T½) desirably in a range of from 60 to 200° C., and more desirably in a range of from 80 to 170° C. In this instance, the ½ melting temperature (T½) is measurements of temperature at a half of a piston travel between start and end points of melt-off of the toner image receiving layer at each specified temperature when heating the toner image receiving layer at a programmed uniform rate applying a specified extrusion load to the piston under specified circumstances after preheating it at an initial setting temperature of, for example, 50° C. for 300 seconds.

(3) The toner image receiving layer has a melt-off start temperature (Tfb) in a range of from 40 to 200° C. but within +20° C. from a melt-off start temperature of toner

(4) The toner image receiving layer has a temperature at which the toner layer attains viscosity of 1×10⁵CP higher than 40° C. but lower than that of toner

(5) The toner image receiving layer has a storage elastic modulus (G′) at a fixing temperature in a range of from 1×10² to 1×10⁵ Pa and a loss elastic modulus (G″) at the fixing temperature in a range of from 1×10² to 1×10⁵ Pa

(6) The toner image receiving layer has a loss tangent (G″/G′) at the fixing temperature, which represents a ration of loss elastic modulus (G″) to storage elastic modulus (G′), in a range of from 0.01 to 10

(7) The toner image receiving layer has a storage elastic modulus (G′) at a fixing temperature is in a range of from −50 Pa from a storage elastic modulus (G′t) for toner at fixing temperature to +2500 Pa from the storage elastic modulus (G′t)

(8) An angle of inclination of molten toner with respect to the toner image receiving layer is less than 50°, and especially less than 40°.

It is preferred for the toner image receiving layer to satisfy the solid state properties disclosed in U.S. Pat. No. 2,788,358, Japanese Unexamined Patent publication Nos. 7-248637, 8-305067 or 10-239889.

The aforementioned solid state property (1) can be estimated using a measuring device well known in the art as a differential scanning calorimeter (DSC). The aforementioned solid state properties (2) and (3) can be estimated using a measuring device such as Flow Tester CFT-500 or CFT-500D (which are manufactured by Shimazu Corporation). The aforementioned solid state properties from (5) to (7) can be estimated using a rotational rheometer such as Dynamic Analyzer RADII manufactured by Scientific Co., Ltd. Further, the aforementioned solid state property (8) can be estimated by a method disclosed in, for example, Japanese Unexamined Patent publication No. 8-334916, using a contact angle measuring device such as manufactured by Kyowa Surface Chemistry Co., Ltd.

It is preferred for the toner image receiving layer to have a surface electrical resistivity in a range of from 1×10⁶ to 1×10¹⁵ Ω/cm² under conditions of a temperature of 25° C. and a relative humidity of 65%. If the lower limit electrical resistivity of 1×10⁶ Ω/cm² is exceeded, this indicates that the amount of toner transferred to the toner image receiving layer is insufficient, then a toner image is apt to diminish in density. On the other hand, if the upper limit electrical resistivity of 1×10¹⁵ Ω/cm² is exceeded, electrical charges are generated too much to transfer a sufficient amount of toner to the toner image receiving layer. This excessive electrical charge generation results in a low density of toner image, adhesion of dust due to electrical charges built up during handling the electrophotographic image receiving sheet, miss-feed of the electrophotographic image receiving sheet, double feed of two or more electrophotographic image receiving sheets, generation of charge prints and an occurrence of fractional absence of toner transfer.

It is preferred for the substrate sheet at a surface opposite to the image receiving layer to have a surface electrical resistivity in a range of from 5×10⁸ to 3.2×10¹⁰ Ω/cm², and more desirably in a range of from 1×10⁹ to 1×10¹⁰ Ω/cm². The surface electrical resistivity can be estimated by the method meeting JIS K 6911 using a measuring device such as R8340 manufactured by Advantest Co., Ltd. Specifically, the electrical resistivity is measured under conditions of a temperature of 20° C. and humidity of 65% after a lapse of one minute from impression of a voltage of 100V on a sample after moisturizing the sample for more than 8 hours under the same conditions.

As was previously mentioned, the electrophotographic image receiving sheet may be provided with other layers. Examples of the layer include a surface protective layer, a backing layer, a contact improvement layer, an under coating layer, a cushioning layer, a charge adjusting or antistatic layer, a reflection layer, a color adjusting layer, a storage stability improvement layer, an anti-adhesion layer, an anti-curling layer and a smoothing layer. These layers may be provided individually or in any combination of two or more.

The surface protective layer is formed over the surface of the electrophotographic image receiving sheet for the purpose of protecting the surface thereof, improving storage stability, handling adaptability and capability in passing through electrophotographic equipments, and providing the electrophotographic image receiving sheet with writability and antioffset resistance. The surface protective layer may be single-layered or multi-layered. Although various types of thermoplastic resin binder or thermosetting resin binder can be used for the surface protective layer, it is preferred to use the same resin binder as used for the toner image receiving layer. The binder of the surface protective layer is not always the same in thermo dynamic and electrostatic characteristics as those of the toner image receiving layer and can be optimized so as to meet the surface protective layer.

The surface protective layer may be blended with additives that are usable for the toner image receiving layer, in particular the matting agent as well as the release agent described in connection with the electrophotographic image receiving sheet. It is preferred for the outermost layer of the electrophotoelectric image receiving sheet (e.g. the surface protective payer when formed) to have high compatibility with toner in light of fixing performance. Specifically, it is preferred for the outermost layer to have a contact angle with molten toner in a range of from 0 to 40°.

The backing layer is formed on a surface of the substrate sheet opposite to the toner image receiving layer for the purpose of providing back side printing adaptability and improving back side printing quality, curling balance and capability in passing through electrophotographic equipments. Though the backing layer is not always bound by color, it is preferred for the backing layer to be in the case where the photoelectric image receiving sheet is of two-sided. The backing layer has a degree of whiteness and a spectral reflecting coefficient both higher than 85% similarly to the toner image receiving layer. In order to improve printing adaptability of both sides of the electrophotoelectric image receiving sheet, the backing layer may consist of a single layer or multiple layers and may be the same in structure as that at the toner image receiving layer. Further, the backing layer may be blended with additives, in particular a matting agent and a charge adjusting agent, that were previously described. In the case of using release oil for the fixing rollers, it is preferred for the backing layer to be of an oil absorbing type.

The electrophotogreaphic image receiving sheet 1 is provided with a contact improvement layer desirably for the purpose of improving contact between the toner image receiving layer and the substrate sheet. The contact improvement layer may be blended with various additives including, in particular a crosslinking agent, that were previously described. Further, it is preferred for the electrophotogreaphic image receiving sheet to be provided with a cushioning layer between the contact improvement layer and the toner image receiving layer for the purpose of improving toner acceptability.

The electrophotogreaphic image receiving sheet may be provided with an intermediate layer between the substrate sheet and the contact improvement layer, between the contact improvement layer and the cushioning layer, between the cushioning layer and the toner image receiving layer, or between the toner image receiving layer and the storage stability improvement layer. In the case where the electrophotogreaphic image receiving sheet consists of the substrate sheet, the toner image receiving layer and the intermediate layer, it is of course to put the intermediate layer between the substrate sheet and the toner image receiving layer.

The electrophotogreaphic image receiving sheet 1 with these additive layers is not bound by thickness, and it is preferred to have a thickness in a rage of from 50 to 350 μm, and more desirably in a range of from 100 to 280 μm, according to purposes.

As was describe above, the electrophotogreaphic image receiving sheet has the toner image receiving layer formed on one or both surfaces of the substrate sheet. The electrophotogreaphic image receiving sheet with the image receiving layer on one surface of the substrate sheet is conveniently used for posters, photographs, self-adhesive seals, etc. The electrophotogreaphic image receiving sheet with the image receiving layers on both surfaces of the substrate sheet is conveniently used for various cards such as a post card, pamphlets, brochures, catalogs, etc.

An electrophotographic image is formed by causing the electrophotogreaphic image receiving sheet to accept toner in a printing or copying process. The toner contains at least a binding resin, a coloring agent and, if needed, a release agent.

Preferred examples of the binding resin include styrene such as styrene or parachlorosthylene; vinyl ester such as vinyl naphthalene, vinyl chloride, vinyl bromide, vinyl fluoride, vinyl acetate, vinyl propionate, vinyl benzoate or vinyl butarate; methylene aliphatic carboxylate ester such as methyl acrylate, ethyl acrylate, n-butyl acrylate, isobutyl acrylate, dodecyl acrylate, n-octyl acrylate, 2-chloroethyl acrylate, phenyl acrylate, methyl α-chloroacrylate, methyl methacrylate, ethyl methacrylate or butyl methacrylate; vinyl nitrile such as acrylonitrile, methacrylonitrile or acrylamide; vinyl ether such as vinyl methyl ether, vinyl ethyl ether or vinyl isobutyl ether; N-vinyl compound such as N-vinyl pyrrole, N-vinyl carbazole, N-vinyl indole or N-vinyl pyrrolidone; homopolymers or copolymers of vinyl monomers of vinyl carboxylate such as methacrylic acid, acrylic acid or cinnamic acid; and various polyester. These binding resin may be used in combination with various wax. It is preferred to use the same type of resins as used for the toner imager eceiving layer.

Coloring agents that are used for ordinary toner can be used without any restriction. Preferred examples of the coloring agent include various pigments, e.g. carbon black, chrome yellow, Hansa yellow, benzidine yellow, slen yellow, quinoline yellow, permanent orange GTR, pyrazolone orange, Vulcan orange, Watchung red, permanent red, brilliant carmine 3B, brilliant carmine 6B, Deipon oil red, pyrazalone red, redole red, rhodamine B lake, lake red C, rose Bengal, aniline blue, ultramarine blue, Carco oil blue, methylene blue chloride, phthalocyanine blue, phthalocyanine green and malachite green oxalate; and various dyes e.g. acridine dyes, xanthene dyes, azoic dyes, benzoquinone dyes, axine dyes, anthraquinone dyes, thioindigo dyes, dioxazine dyes, thiazine dyes, azomethine dyes, indigo dyes, thioindigo dyes, phthalocyanine dyes, aniline black dyes, polymethine dyes, triphenylmethane dyes, diphenylmethane dyes, thiazine dyes, thiazole dyes and xanthene dyes. These pigments or dyes may be used individually or in any combination of two or more.

It is preferred for the toner to contain the coloring agent in a range of from 2 to 8 weight %. The toner does not lose tinting strength when containing the coloring agent higher than 2 weight %.

Although all types of wax conventionally known in the art can be used as the releasing agent for the toner in principle, preferred examples of the release agent include higher crystalline polyethylene wax with a comparatively low molecular weight, Fischer-Tropsch wax, amide wax and polar wax containing nitrogen such as a urethane compound. It is preferred for the polyethylene wax to have a molecular weight less than 1000, and more desirably in a range of from 300 to 1000.

It is preferred to use the compound having an urethane bond because it keeps itself in a solid state due to coagulation power of its polar group even though it has only a small molecular weight and can be set to a higher melting temperature with respect to a low molecular weight. It is preferred for the compound to have a molecular weight in a range of from 300 to 1000. Preferred examples of the raw material for the compound include a combination of a diisocyanate compound and monoalcohol, a combination of monoisocyanate and monoalcohol, a combination of dialcohol and monoisocyanate, a combination of trialcohol and monoisocyanate, a combination of triisocyanate and monoalcohol and the like. In order to keep the compound from having a higher molecular weight, it is preferred to combine a compound of multifunctional group and a compound monofunctional group and is important for the compound to have quantitatively equivalent functional groups.

Preferred example of monoisocyanate compound include dodecyl isocyanate, phenyl isocyanate, derivatives of phenyl isocyanate, naphthyl isocyanate, hexyl isocyanate, benzyl isocyanate, butyl isocyanate, aryl isocyanate and the like. Preferred example of diisocyanate compound include tolylene diisocyanate, 4,4′ diphenyl methane diisocyanate, toluene diisocyanate, 1,3-phenylene diisocyanate, hexamethylene diisocyanate, 4-methyl-m-phenylene diisocyanate, isophorone diisocyanate and the like.

Preferred example of monoalcohol include methanol, ethanol, propanol, butanol, pentanol, hexanol, heptanol and other general alcohol. Preferred example of dialcohol include, but not limited to, various glycol such as ethylene glycol, diethylene glycol, triethylene glycol, trimethylene glycol, etc. Preferred example of trialcohol include, but not limited to, trimethylol propane, triethylol propane, trimethanol ethane, etc.

Each of the urethane compounds may be blended with the toner together with a resin and/or a coloring agent like ordinary release agents so as to provide a mixed pulverized type of toner. When using the compound for toner in an emulsion polymerization-coagulation melting method, the compound is dispersed in water together with polyelectrolytes such as an ionic surface-active agent, a polymer acid and a polymer base, heated to a temperature higher than its melting temperature and sheared to particulates of less than 1 μm. A dispersion liquid of the releasing particulates can be blended with the toner together with a dispersion liquid of resin particulates and/or a liquid of coloring agent particulates.

The toner may be blended with other components such as an additive, a charge adjusting agent, inorganic particulates, etc. Preferred examples of the additive include various magnetic materials: specifically metals such as ferrite, magnetite, reduced iron, cobalt, nickel, manganese, etc.; alloys; and compounds containing these metals.

Preferred examples of the charge adjusting agent include dye such as quaternary ammonium salt compounds, nigrosin compounds, a complex of aluminum, iron or chrome; and various triphenylmethane pigments ordinarily used as antistatic agent. In light of controlling ion strength having an effect on stability of the toner during coagulation and melting and reducing wastewater pollution, it is preferred to use a charge adjusting agent that is hardly dissolved in water.

Preferred examples of the inorganic particulate include all of the conventional additives that are externally applied to surfaces of toner particles such as silica, alumina, titania, calcium carbonate, magnesium carbonate, tricalcium phosphate, etc. It is preferred to use in the form of a dispersion of the inorganic particulates with an ionic surface-active agent, polymer acid and/or a polymer base.

Surface-active agents can be used for the purpose of emulsion polymerization, seed polymerization, dispersion of pigment, dispersion of resin particles, dispersion of release agent, coagulation and stabilization of them. It is effective to use anion surface-active agents such as a sulfate salt surface-active agent, a sulfonate surface-active agent, a phosphate surface-active agent, a soap surface-active agent, etc.; cationic surface-active agents such as an amine salt surface-active agent, a quaternary ammonium salt surface-active agent, etc.; and nonionic surface-active agents such as polyethylene glycol surface-active agent, a surface-active agent of alkylphenol ethylene oxide adduct, polyhydric alcohol surface-active agent, etc. In order to disperse these additives, it is possible to use popular dispersing machines such as a rotary shearing type of homogenizer, a ball mill, a sand mill or the like.

The toner may further contain an external additive if needed. Preferred examples of the additive include inorganic particles such as SiO₂ particles, TiO₂ particles, Al₂O₃ particles, CuO particles, ZnO particles, SnO₂ particles, Fe₂O₃ particles, MgO particles, BaO particles, CaO particles, K₂O particles, NaO₂ particles, ZrO₂ particles, CaO.SiO₂ particles, K₂O.(TiO₂)ₙ particles, Al₂O₃.2SiO₂ particles, CaCO₃ particles, MgCO₃ particles, BaSO₄ particles or MgSO₄ particles; and organic particles such as fatty acid particles, particles of a derivative of fatty acid, metal acids of them, fluorocarbon resin particles, polyethylene resin particles or acryl resins particles. It is preferred for these particles to have an average particle size in a range of from 0.01 to 5 μm, and more desirably in a range of from 0.1 to 2 μm.

Although various methods may be used to manufacture the toner, it is preferred to employ a method comprising the following processes (i) to (iii):

(i) A process of preparing a dispersion liquid of coagulated particles by forming the coagulated particles in a dispersion liquid of resin particles

(ii) A process of forming particulate-adhered coagulated particles by mixing a dispersion liquid of particulates to the dispersion liquid of coagulated particles

(iii) A process of forming toner particles by heating and melting the particulate-adhered coagulated particles.

The following description will be directed to desired solid state properties for the toner. It is preferred for the toner to have a volumetric average particle size in a range of from 0.5 to 10 μm. If the volumetric average particle size exceeds the lower limit, the toner has adverse effects on its handling (replenishing, cleaning) adaptability and flowability and on productivity. On the other hand, if the volumetric average particle size exceeds the upper limit, the toner has an adverse effect on image quality and resolution due to graininess and transferability.

It is further preferred for the toner to have a volumetric average particle size distribution index (GSDv) less than 1.3 and a ratio (GSDv)/GSDn) of a volumetric average particle size distribution index (GSDv) relative to a number average particle size distribution index (GSDn) equal to or greater than 0.9 while satisfying the volumetric average particle size specified above. In addition, it is preferred for the toner to have an average of profile factor, that is expressed in terms of the equation as below, in a range of from 1.00 to 1.50 while satisfying the volumetric average particle size specified above.

Profile factor=(π×L²)/(4×S)

where L is the greatest size of toner particle and S is the projected area of toner particle.

When the toner satisfies the requirements as set forth above, the toner has an positive effect on image quality, in particular graininess and resolution of an image, prevents an occurrence of fractional absence of toner transfer and/or an occurrence of blurred toner image, and is hardly apt to have an adverse effect on its handling adaptability even though the average particle size is insufficiently small.

It is preferred for the toner itself to have a storage elastic modulus (G′) (that is measured with an angular frequency of 10 rad/sec) at a temperature of 150° C. in a range of from 10 to 200 Pa in light of improving image quality and preventing an occurrence of offset in the fixing process.

The following description will be directed to processes of forming an image on the electrophotographic image receiving sheet. The image forming process according to a first embodiment comprises a step of forming a toner image on an electrophotographic image receiving sheet, a step of heating and applying pressure on the electrophotographic image receiving sheet from the toner image formed surface between a fixing belt and a roller, and a step of removing the electrophotographic image receiving sheet from the fixing belt after cooling it.

The image forming process according to a second embodiment comprises a step of forming a toner image on an electrophotographic image receiving sheet, a step of fixing the toner image with a heating roller, a step of heating and applying pressure on the electrophotographic image receiving sheet from the toner image formed surface between a fixing belt and a roller, and a step of removing the electrophotographic image receiving sheet from the fixing belt after cooling it.

There are two image transfer processes, namely a direct transfer usually used in an ordinary electrophotographic process in which a toner image formed on a developing roller is transferred directly to an image receiving sheet and an intermediate belt transfer process in which a toner image is primarily transferred to an intermediate belt and then to an image receiving sheet. As to the electrophotographic image receiving sheet of the present invention, it is preferred to use the intermediate belt transfer process in light of environmental stability and high image quality.

An electrophotographic apparatuse equipped with a fixing belt is used to transfer and fix a toner image onto the electrophotographic image receiving sheet. There are two types of belt fixing process, namely an oilless belt fixing process such as described Japanese Unexamined Patent Publication No. 11-352819 and a process for carrying out secondary transfer and fixing simultaneously such as described in Japanese Unexamined Patent Publication Nos. 5-341666 and 11-231671. The fixing belt type electrophotographic apparatus is equipped with at least a toner fixing unit comprising a heating and pressurizing part for melting toner and applying pressure to the toner, a fixing belt for conveying an electrophotographic image receiving sheet with the toner adhered thereto in contact with the toner image receiving layer and a cooling part for cooling the heated electrophotographic image receiving sheet adhered to the fixed belt as appropriate. As a result of using the fixing belt type electrophotographic apparatus to form an image on electrophotographic image receiving sheet, the toner adhered to the toner image receiving layer is extremely finely fixed without spreading over and cooled and solidified in contact with the fixing belt, so that the toner is received by and completely buried in the toner image receiving layer with the consequence that the electrophotographic image receiving sheet provides a toner image that is glossy and smooth and has no shoulders.

When the electrophotographic image receiving sheet is used to form an image thereon by the oilless belt fixing process, the electrophotographic image receiving sheet is significantly improved in offset property.

It is of course that the electrophotographic image receiving sheet comports suitably with image forming processes other than the oilless belt fixing process. For example, the electrophotographic image receiving sheet is suitably used to form a full color image improved in image quality and prevented from cracking. As is well known, an ordinary color electrophotographic apparatus comprises an image receiving sheet carrying unit, a latent image forming unit, a developing unit disposed in close proximity to the latent image forming unit and an intermediate toner image transfer unit located in close proximity to the latent image forming unit and the image receiving sheet carrying unit at the center of the apparatus additionally according to types of apparatus.

As an image forming processes suitable for improving image quality, it is preferred to use an adhesion transfer process or a heat-assisted transfer process in place of or in combination with an electrostatic transfer process or a bias-roller transfer process. These transfer processes are specifically disclosed in, for example, Japanese Unexamined Patent Publication Nos. 63-113576 and 5-341666. A process that is particularly preferred is the heat-assisted transfer process using an intermediate transfer belt. One example of the intermediate belt is an endless belt made of electroformed nickel. It is further preferred to provide a cooling device for an intermediate belt after a stage of toner image transfer to the electrophotographic image receiving sheet or in a last half stage of toner image transfer to the electrophotographic image receiving sheet. The cooling device cools toner (a toner image) to a temperature lower than a melting temperature of a binder resin of the toner or to a temperature lower than +10° C. above a glass-transition temperature of the toner with the consequence that a toner image is efficiently transferred to the electrophotographic image receiving sheet and easily separated from the intermediate transfer belt.

Image fixing is an important process exercising a decisive influence on gloss and smoothness of a resultant image. There are two types of fixing process, namely a heating and pressurizing roller fixing process and a belt fixing process. In light of image quality, i.e. glossy and smooth image, it is preferred to employ the belt fixing process. There have been known an oilless belt fixing process such as disclosed in Japanese Unexamined Patent Publication No. 11-352819 and a process in which secondary image transfer and toner fixing are carried out simultaneously such as disclosed in Japanese Unexamined Patent Publication Nos. 5-341666 and 11-352819. Primary image fixing may be carried out with a heating roller before heating and pressurizing by a fixing belt and a fixing roller.

The fixing belt at its exterior surface may be fluoritated and/or siliconized for the purpose of preventing exfoliation and/or offset of toner components. It is preferred for the fixing belt to be accompanied by a cooling device for cooling the electrophotographic image receiving sheet in the last half of the fixing process for easy separation of the electrophotographic image receiving sheet from the fixing belt. The cooling device is capable of cooling toner or an toner image to a temperature lower than a melting temperature of a binder resin of the toner and/or a melting temperature of a polymer of the tonerimage receiving layer of the toner image receiving layer, or otherwise to a temperature lower than +10° C. above a glass-transition temperature of the toner. On the other hand, at the beginning of fixing, it is necessary for the toner image receiving layer or the toner to be heated sufficiently to a temperature for melting. Specifically, it is preferred to set a cooling temperature in a range of from 30 to 70° C. practically and in a range of from 100 to 180° C. at the beginning of fixing.

The following description will be directed to one example of typical exelctrphotographic apparatus equipped with a fixing belt according to a preferred embodiment of the present invention with reference to the accompanying drawing.

The electrophotographic apparatus (not shown) transfers toner 12 to an electrophotographic image receiving sheet 1 and then conveys the electrophotographic image receiving sheet 1 with the toner 12 adhered thereto to a fixing position A between a heating roller 14 and a pressurizing roller 15. During passing through between these rollers 14 and 15, a toner image receiving layer or the toner 12 of the electrophotographic image receiving sheet 1 is pressurized and heated at a temperature sufficiently high for melting (a fixing temperature). In this instance, the fixing temperature which refers to a temperature of the surface of the image receiving layer measured at a nip in the position A between the heating and pressurizing rollers 14 and 15 is preferably in a range of from 80 to 190° C., and more preferably in a range of from 100 to 170° C. The fixing pressure which refers to a pressure measured at the nip in the position A between the heating and pressurizing rollers 14 and 15 is preferably in a range of from 1 to 10 kg/cm², and more preferably from 2 to 7 kg/cm². The electrophotographic image receiving sheet 1 thus heated and pressurized is carried with a fixing belt 13 passing through a cooling device 16. Before arriving at the cooling device 16, A releasing agent (not shown) discretely distributed in the toner image receiving layer is sufficiently heated and melts and, as a result, exudes on the surface of the toner image receiving layer to form a layer or film of the release agent. Thereafter, the electrophotographic image receiving sheet 1 is conveyed to the cooling device 16 with the fixing belt 13 and cooled to a temperature lower than a melting temperature of a binder resin of the toner and/or a melting temperature of a polymer of the toner image receiving layer, or otherwise to a temperature lower than +10° C. above a glass-transition temperature of the toner, desirably to a temperature in a range of from 20 to 80° C., and more desirably to an ambient temperature of approximately 25° C. As a result, the layer or film of the release agent formed on the toner imager receiving layer is cooled down and solidified.

The electrophotographic image receiving sheet 1 after cooling is further carried to a release position B where the fixing belt 13 is guided with a tension roller 17 toward the heating roller 14. In consequence, the electrophotographic image receiving sheet separated from the fixing belt 13 at the release position B. In this instance, it is preferred for the tension roller 17 to have a diameter sufficiently small to allow the electrophotographic image receiving sheet 1 to peel off from the fixing belt 13 with its own stiffness or firmness. It is preferred to use an endless fixing belt made of a base material such as polyimide, electroformed nickel or aluminum.

It is preferred to form a thin film of at least one material selected from the group of silicone rubber, fluorocarbon rubber, silicone resin and fluorocarbon resin on the surface of the fixing belt 13. More preferably, it is suitable to form a fluorocarbon silicone rubber layer uniform in thickness on the surface of the fixing belt 13, or otherwise to form a silicone rubber layer uniform in thickness on the surface of the fixing belt 13 and a fluorocarbone siloxane rubber layer over the silicone rubber layer.

It is preferred to use fluorocarbone siloxane rubber having a perfluoroalkyl ether group and/or a perfluoroalkyl group in a principal chain. Preferred examples of the fluorocarbone siloxane rubber include (A) a fluorocarbone polymer composed of fluorocarbon siloxane in major proportion and an aliphatic unsaturated hydrocarbon group, (B) organopolysiloxane and/or fluorocarbon siloxane that has more than two ≡SiH groups in one molecule and have a ≡SiH group content from one to four times ill molar weight as much as the amount of aliphatic unsaturated hydrocarbon group in fluorocarbonsiloxane rubber, (C) filler, and (D) a hardened material of a composition of fluorocarbonsiloxane rubber having an effective amount of catalyst.

More specifically, the component (A) is composed of fluorocarbon siloxane having a repeating unit expressed in herms of the following general equation (I) in major proportion and an aliphatic unsaturated hydrocarbon group.

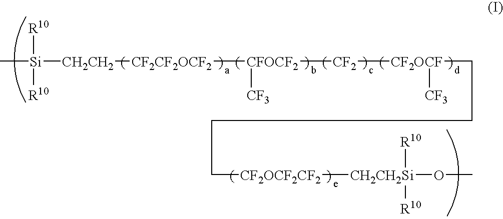

where R¹⁰ is a substitutable or non-substitutable univalent hydrocarbon group having a carbon number of from 1 to 8, desirably an alkyl group having a carbon number between 1 and 8 or an alkenyl group having a carbon number of 2 or 3, and more desirably a methyl group; a and e take values of 0 or 1, respectively; b and d are integers between 1 and 4, respectively; c is an integer between 0 and 8, and x is an integer greater than 1 and desirably between 10 and 30.

A specific example of the component (A), i.e. the fluorocarbone polymer, is expressed in terms of the following equation (II):

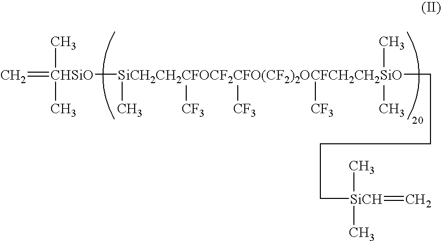

A preferred example of the organopolysiloxane, component (B), having ≡SiH groups is organohydrogen polysiloxane having at least two hydrogen atoms bonded to silicon atoms in a molecule. In the case where the composition (A), i.e. the fluorocarbone polymer, has an aliphatic unsaturated hydrocarbon group, the organohydrogen polysiloxane can be used as a hardening agent for the fluorocarbonsiloxane rubber component. That is, in this case, a hardened material is formed through an addition reaction occurring between an aliphatic unsaturated hydrocarbon group of the fluorocarbonsiloxane and an atom bonded to silicon atoms of the organohydrogen polysiloxane. Various organohydrogen polysiloxane that are used for an addition curing type composition of silicon rubber can be used for the organohydrogen polysiloxane. It is preferred for the organohydrogen polysiloxane to have ≡SiH groups at least one, desirably one to five, for one aliphatic unsaturated hydrocarbon group of the component (A) i.e. the fluorocarbon siloxan.

A preferred example of the fluorocarbon, component B, having ≡SiH groups is the unit expressed in terms of chemical formula (I) or the unit expressed in terms of chemical formula (I) that has a dialkyl hydrogensiloxy group substituted for R¹⁰ and ends with SiH group such as a dialkyl hydrogenisiloxy group or a silyl group, and is expressed in terms of the following chemical equation (III).

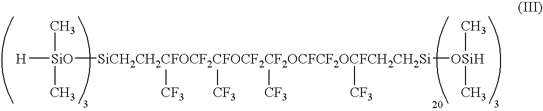

Examples of the filler, component (C), include various fillers that are conventionally used in general silicon rubber compositions; e.g. a reinforcing filler such as aerosol silica, precipitated silica, carbon powder, a titanium dioxide, an aluminum oxide, quartz powder, talc, sericite or bentonite; and a fiber filler such an asbestos, a glass fiber or an organic fiber.

Examples of the catalyst, component (D), include various catalysts; e.g. an addition reaction catalyst well known in the art such as a chloroplatinic acid, an alcohol-modified chloroplatinic acid or a complex of chloroplatinic acid and olefin; a composition of platinum black or palladium supported by alumina, silica or carbon; a complex of rhodium and olefin; and an element of the VIII family of periodic table such as chlorotris (triphenylphosphine)rhodium (Wilkinson catalyst) or rhodium (III) acetylacetonate or a compound of them. It is preferred for these complexes to be used as a solution with an alcohol solvent, an ether solvent or a hydrocarbon solvent.

If needed, the fluorocarbonsiloxane rubber composition may be blended with various compounding agents without detriment to the purpose of improving solvent resistance of the present invention. Examples of the compounding agent include a dispersing agent such as diphenylsilanediol, a low polymarization grade of dimethylpolysiloxane with dimethyl-polysiloxan of a molecular chain ended with a blocking hydroxyl group or hexamethyldisilazane; a thermal resistance improving agent such as a ferrous oxide, a ferric oxide, a cerium oxide, a ferric octylate; and a coloring agent such as pigment.

The fixing belt is prepared by applying a layer of a fluorocarbonsilixane rubber composition to a belt base of heat-resistant resin or metal and curing it with heat. If needed, the fixing belt may be coated with a coating liquid of fluorocarbonsilixane rubber composition diluted with a solvent such as m-xylene hexafluoride or benzotrifluoride by a general coating method such as spray coating, dip coating or knife coating. Though the heating for cure is not bound by temperature and time, it is preferred to perform heating and curing in a temperature range of from 100 to 500° C. and in a time range of from 5 seconds to 5 hours according to types of the belt base and belt manufacturing process. Although the fluorocarbonsiloxane rubber composition layer of the fixing belt is not always bound by thickness, it is preferred for the layer to have a thickness of from 20 to 500 μm and more desirably in a range of from 40 to 200 μm.

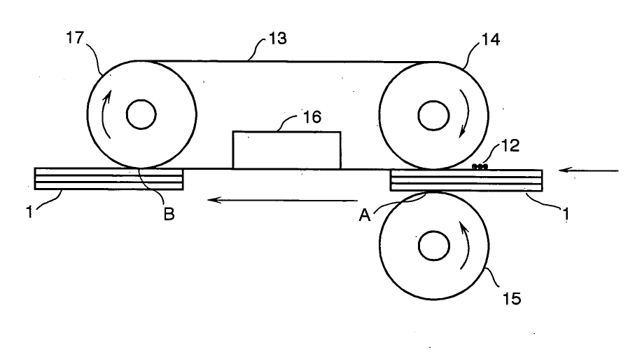

Electrophotographic processes for forming an image on the electrophotographic image receiving sheet are not limited to those shown in and explained with reference to FIG. 2 as long as using a fixing belt and include almost all ordinary processes that are conventionally used. For example, the electrophotographic image receiving sheet of the present invention can be used to form a full color image thereon by the conventional color electrophotographic apparatuses. As is well known, an ordinary electrophotographic apparatus comprises an image receiving sheet carrying unit, a latent image forming unit, a developing unit disposed in close proximity to the latent image forming unit, a developing unit located in close proximity to the latent image forming unit, and, according to types of apparatus, an intermediate toner image transfer unit located in close proximity to the latent image forming unit and the image receiving sheet carrying unit at the center of the apparatus.

As an image forming processes suitable for improving image quality, it is preferred to use an adhesion transfer process or a heat-assisted transfer process in place of or in combination with an electrostatic transfer process or a bias-roller transfer process. These transfer processes are specifically disclosed in, for example, Japanese Unexamined Patent Publication Nos. 63-113576 and 5-341666. A process that is particularly preferred is the heat-assisted transfer process using an intermediate transfer belt in the case of using a small particle size of toner.

The image forming process of the present invention prevents an occurrence of separation between the electrophotographic image receiving sheet and toner and/or an occurrence of offset between the electrophotographic image receiving sheet and toner, and achieving stable sheet feeding with the consequence that an image formed on the electrophotographic image receiving sheet is satisfactory glossy and sounds like a quality photograph.

The following description will be directed to the electrophotographic image receiving sheet of the invention by way of working and comparative examples by which the present invention is not bounded. In the description, the terms “%” and “part” as used herein shall mean “mass %” and “part by mass,” respectively.

### WORKING EXAMPLE 1

Base paper pulp for a substrate sheet was prepared by beating bleached kraft pulp of a broadleaf tree (LBKP) to 300 cc (Canadian Freeness Standard Freeness: CFS) so as to have a fiber length of 0.58 mm with a disk refiner and blending it with the following additives in weight % with respect to pulp weight.

| Additives | Weight % |
|---|---|
| Cation starch | 1.2 |
| Alkylketenedimer (AKD) | 0.5 |
| Anion polyacrylamide | 0.3 |
| Epoxidized fatty acid amine (EFA) | 0.2 |
| Polyamide polyamine epichlorohydrin | 0.3 |

In this instance, an alkyl part of alkylketenedimer (AKD) is derived from fatty acid composed of behenic acid as a primary component and a fatty acid part of epoxidized fatty acid amine (EFA) is derived from fatty acid composed of behenic acid as a primary component.

A base paper of basic weight of 150 g/m² was made from the base paper pulp by a fourdrinier machine. PVA and CaCl₂ was adhered to the base paper sheet at proportions of 1.0 g/m² and 0.8 g/m², respectively, at an intermediate stage of a drying zone by a sizing press machine. The base paper was adjusted in paper density to 1.01 g/m³ at a final stage by a soft calender. The base paper was passed through a roller so as to keep one surface of the base paper on which a toner image receiving layer will be formed in contact with the roller. The roller was maintained at a surface temperature of 140° C. The base paper thus prepared had a whiteness of 91%, an Oken smoothness of 265 seconds and a Stockigit sizing degree of 127 seconds.

After processing the base paper with a colona discharge treatment, a lamination layer of a polyethylene resin was formed on a back surface of the base paper by extrusion laminating. Specifically, a polyethylene resin having a composition indicated in Table I was extruded at a melting state film extrusive temperature of 320° C. and an extrusive line speed of 250 m/min to form a melting state single layer film 22 μm thick using a cooling roller having a mat surface roughness of 10 μm.

TABLE I

| Component | MFR (g/10 minutes) | Density (g/m³) | Amount (weight %) |
|---|---|---|---|
| HDPE | 12 | 0.967 | 70 |
| LDPE | 3.5 | 0.923 | 30 |

Thereafter, a lamination layer of a mixture was formed on a front surface of the base paper on which a toner image receiving layer will be formed by single layer extrusion laminating. The mixture was prepared by blending a polyethylene resin and masterbatch ultramarine blue pigment containing a masterbatch titanium oxide such as indicated in Table II so as to have a net composition indicated in Table III. Specifically, the mixture was extruded at a melting state single layer film extrusive temperature of 320° C. and an extrusive line speed of 250 m/min to form a single layer film 29 μm in thickness using a cooling roller having a mat surface roughness of 0.7 μm.

TABLE II

| Component | Content (weight %) |
|---|---|
| LDPE (ρ = 0.921 g/m³) | 37.98 |
| Anatase type titanium dioxide | 60 |
| Zinc stearate | 2 |
| Antioxidant | 0.02 |

TABLE III

| Component | Content (weight %) |
|---|---|
| LDPE (ρ = 0.921 g/m³) | 67.7 |
| Anatase type titanium dioxide | 30 |
| Zinc stearate | 2 |
| Antioxidant | 0.3 |

An electrophotoraphic image receiving sheet of Working Example 1 (electrophotoraphic image receiving sheet WE 1) was prepared by coating a composition specified below by a wire coater so as to have a dried amount of 15 g/cm² and drying it to form a toner image receiving layer, so as thereby to complete an electrophotographic image receiving sheet.

### Toner Image Receiving Layer

| | |
|---|---|
| Water-dispersed polyester resin (KZA-1449: Unitika Ltd.) | 100 g |
| Carnauba wax (Serzole 524: Chukyo Oils & Fats Co., Ltd.) | 4 g |
| Titanium dioxide (Taipek RA-220: Ishiharasangyo Ltd.) | 0.9 g |
| Water | 40 g |

### WORKING EXAMPLE 2

An electrophotographic image receiving sheet of Working Example 2 (electrophotoraphic image receiving sheet WE 2) was the same as that of Working Example 1 except that a composition specified below was used to form a toner image receiving layer.

### Toner Image Receiving Layer

| | |
|---|---|
| Water-dispersed polyester resin (KZA-7049: Unitika Ltd.) | 100 g |
| Carnauba wax (Serzole 524: Chukyo Oils & Fats Co., Ltd.) | 4 g |
| Titanium dioxide (Taipek RA-220: Ishiharasangyo Ltd.) | 0.9 g |
| Water | 40 g |

### WORKING EXAMPLE 3

An electrophotographic image receiving sheet of Working Example 3 (electrophotoraphic image receiving sheet WE 3) was the same as that of Working Example 1 except that a composition specified below was used to form a toner image receiving layer.

### Toner Image Receiving Layer

| | |
|---|---|
| Polyester resin (TaftonU-5: Kao Co., Ltd.) | 400 g |
| Titanium dioxide (Taipek RA-220: Ishiharasangyo Ltd.) | 60 g |
| TPP (Daihachi Chemicals Co., Ltd.) | 34.8 g |
| Methyl ethyl ketone | 800 g |

### COMPARATIVE EXAMPLE 1

An electrophotographic image receiving sheet of Comparative Example 1 (electrophotographic image receiving sheet CE 1) was the same as that of Working Example 1 except that a composition specified below was used to form a toner image receiving layer.

### Toner Image Receiving Layer

| | |
|---|---|
| Polyester resin (TaftonU-5: Kao Co., Ltd.) | 100 g |
| Titanium dioxide (Taipek RA-220: Ishiharasangyo Ltd.) | 60 g |
| Methyl ethyl ketone | 800 g |

### COMPARATIVE EXAMPLE 2

An electrophotographic image receiving sheet of Comparative Example 2 (electrophotographic image receiving sheet CE 2) was the same as that of Working Example 1 except that a composition specified below was used to form a toner image receiving layer.

### Toner Image Receiving Layer

| | |
|---|---|
| Polyester resin (A copolymer* of terephthalic acid and ethylene | 100 g |
| oxide-modified bisphenol A: number-average | |
| molecular weight = 5000; glass-transition | |
| temperature (TG) = 650° C.) | |
| Titanium dioxide (Taipek RA-220: Ishiharasangyo Ltd.) | 60 g |
| Methyl ethyl ketone | 800 g |

*polyester disclosed in Japanese Unexamined Patent Publication No. 11-212292

Qualitative evaluations were made in connection with film cracks, breaking extension and glossiness for the electrophotographic image receiving sheets WE1 to WE3 and CE1 and CE2.

An occurrence of cracks on an electrophotographic image receiving sheet was estimate by visually observing whether surface cracks are in existence in a sample of the electrophotographic image receiving sheet wound around a cylinder 5 cm in diameter.

Breaking extension of an electrophotographic image receiving sheet was estimated on the basis of breaking extension of a sample of the electrophotographic image receiving sheet measured by a method meeting JIS K7127. The sample was prepared by coating a composition for a toner image receiving layer specified above from 10 to 40 μm in thickness on a hydrophobic substrate sheet such as a polyethylene sheet with a wire bar and drying the composition layer and cutting a 5×70 mm strip out of the substrate sheet. Breaking extension of the sample was measured under tension of 1 mm/min by Tensilon RTM-50 (which is manufactured by Orientec Co. Ltd.). The breaking extension is represented as a percentage of elongation of the sample at an occurrence of fracture relative to the original length of the sample.

The following method was used to measure glossiness of the electrophotographic image receiving sheet based on an image formed on the electrophotographic image receiving sheet by a fixing belt type electrophotographic apparatus.

Digital variable angle glossmeter (UGV-5G manufactured by Suga Test Machines Co., Ltd.) was used to measure 20° glossiness, in particular minimum 20° glossiness, of images printed at six different gradations (0%, 20%, 40%, 60%, 80% and 100%) in B/W in 10 cm square image areas of the respective electrophotographic image receiving sheets with a printer.

Sample images such as a solid white image, a gray image (R=G=B=0%), a 100% black image and a woman's portrait were printed on the respective electrophotgraphic image receiving sheets with a laser color printer (C-2220 manufactured by Fuji Xerox Co., Ltd.). The fixing belt used in the laser color printer was provided with two layers, namely a silicone rubber layer 40 μm in thickness and a fluorocrbone siloxane rubber layer 20 μm in thickness, formed on a polyimide base layer of the fixing belt. Specifically, the silicone rubber layer was formed by applying a silicone rubber primer (e.g. DR39-115 manufactured by Toray Dow Corning Silicone Co., Ltd.) to the polyimide base layer, drying it with air for 30 minutes, dipping it in a coating liquid consisting of 100 parts of a precursor of silicone rubber (e.g. DY35-796AB) and 30 parts of n-hexane to form a coating layer, and heating the coating layer at 120° C. for 10 minutes for primary valucanization. The fluorocrbone siloxane rubber layer was formed by dipping the polyimide base layer with the silicone rubber layer formed thereon in a coating liquid consisting of 100 parts of a precursor of fluorocrbone siloxane rubber (e.g. SIFEL 610 manufactured by Shinetsu Chemical Industry Co., Ltd.) and 20 parts of fluorine solvent (a mixed solvent of m-xylenhexafluoride, perfluoroalkane, perfluoro(2-butyl tetrohydrofuran)) to form a coating layer over the silicone rubber layer, heating the coating layer at 120° C. for 10 minutes for primary valucanization and then at 180° C. for four hours for secondary valucanization. Image printing was performed under the condition that a toner image was fixed at a toner fixing temperature, i.e. a hearing roller temperature of 155° C. and a pressurizing roller temperature of 130° C. while the electrophotogeaphic image receiving sheet was carried at, in principal, a speed of 30 mm/sec. The image was printed in a predetermined pattern of 5 cm square solid white images, 5 cm square solid gray images, 5 cm square solid black images and a woman's portrait on the electrophotogeaphic image receiving sheet.

The result of qualitative evaluations s is shown in the following table in which a symbol ∘ indicates that the electrophotographic image receiving sheet is free from defects in surface cracks or surface glossiness and a symbol X indicates that the electrophotographic image receiving sheet is unacceptable regarding surface cracks and surface glossiness.

| | | Breaking extension | |
|---|---|---|---|
| Example | Cracks | (%) | Glossiness |
| WE1 | ◯ | 1.37 | ◯ |
| WE2 | ◯ | 2.93 | ◯ |
| WE3 | ◯ | 0.27 | ◯ |
| CE1 | X | 0.14 | X |
| CE2 | X | 0.09 | X |

While the invention has been described in detail in conjunction with specific embodiments thereof, it will be apparent to those skilled in the art that various other embodiments and variants can be made without departing from the spirit and scope of the invention.

What is claimed is:

1. An electrophotographic image receiving sheet for use in an electrophotography comprising:
a substrate sheet;
a toner image receiving layer formed on said substrate sheet;
wherein said toner image receiving layer has breaking extension greater than 0.2%.

2. An electrophotographic image receiving sheet as defined in claim 1, wherein said toner image receiving layer has a thickness in a range of from 1 to 30 μm.

3. An electrophotographic image receiving sheet as defined in claim 1(2), wherein said toner image receiving layer contains either one of a water-soluble polymer and a water-dispersant polymer.

4. An electrophotographic image receiving sheet as defined in claim 1 (2, 3), wherein said substrate sheet comprises one selected from a group of base paper, synthetic paper, synthetic resin paper, coated paper and laminated paper.

5. An electrophotographic image forming process for forming an image on an electrophotographic image receiving sheet comprising a substrate sheet and a toner image receiving layer which is formed on said substrate sheet and has breaking extension greater than 0.2%, the electrophotographic image forming process comprising the steps of:
forming a toner image on the electrophotographic image receiving sheet;
heating and pressurizing the electrophotographic image receiving sheet with a toner image fixing belt and a roller;
cooling the electrophotographic image receiving sheet from while conveying the electrophotographic image receiving sheet with a side of the electrophotographic image receiving sheet at which said toner image is formed in contact with said toner image fixing belt; and
removing the electrophotographic image receiving sheet from said toner image fixing belt.

6. An electrophotographic image forming process as defined in claim 5, and further comprising the step of fixing said toner image with a heating roller before heating and pressurizing the electrophotographic image receiving sheet.

7. An electrophotographic image forming process method as defined in claim 5, wherein said toner image fixing belt has a surface layer of fluorocarbone siloxane rubber having an uniform thickness.

8. An electrophotographic image forming process as defined in claim 5, wherein said toner image fixing belt has an under surface layer of silicon rubber having an uniform thickness and an over surface layer of fluorocarbone siloxane rubber formed over said under surface layer.

9. An electrophotographic image forming process as defined in claim 14, wherein said fluorocarbone siloxane rubber has at least one of a perfluoroalkyl ether group and a perfluoroalkyl group in a principal chain.
